(19) United States
(12) Patent Application Publication
(10) Pub. No.: US 2025/0239638 A1
(43) Pub. Date: Jul. 24, 2025

(54) COMPOSITE INCLUDING FLUORINATED POLYMER AND LITHIUM FLUORIDE NANOPARTICLES AND ARTICLES INCLUDING THE SAME

(71) Applicant: 3M INNOVATIVE PROPERTIES COMPANY, St. Paul, MN (US)

(72) Inventors: Mark W. Muggli, Emmerting (DE); Gregg D. Dahlke, St. Paul, MN (US); Denis Duchesne, Woodbury, MN (US); Thorsten Gerdes, Eckersdorf (DE); Patrick K. Heimerdinger, Bayreuth (DE); Klaus Hintzer, Kastl (DE); Stefan Huber, Loiching (DE); Maximilian Kutter, Berlin (DE); Andreas Rosin, Bayreuth (DE); Christina Roth, Bayreuth (DE); Arne Thaler, Emmerting (DE); Fee Zentis, Waging am See (DE)

(21) Appl. No.: 18/698,430

(22) PCT Filed: Oct. 5, 2022
(86) PCT No.: PCT/IB2022/059513

§ 371 Date: Apr. 4, 2024

Related U.S. Application Data
(60) Provisional application No. 63/253,296, filed on Oct. 7, 2021.

(51) Int. Cl. H01M 8/1051; C25B 9/23; C25B 13/08; H01M 8/10; H01M 8/1004; H01M 8/1039

(52) U.S. Cl. CPC H01M 8/1051; C25B 9/23; C25B 13/08; H01M 8/1004; H01M 8/1039; H01M 2008/1095

(57) ABSTRACT

Described herein is a composite comprising a fluorinated polymer and nanoparticles of lithium fluoride. The lithium fluoride has an average BET surface area of at least 10 m²/g. The fluorinated polymer includes a fluorinated polymer backbone chain and a plurality of groups represented by formula —SO₂X, in which each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′, or —OZ, and Z is independently a hydrogen, an alkali-metal cation, or a quaternary ammonium cation, X′ is independently —NZH or —OZ, and each d is independently 1 to 6. A polymer electrolyte membrane, an electrode, and a membrane electrode assembly including the composite are also provided.

### TECHNICAL FIELD

The use of high surface area lithium fluoride nanoparticles in dispersions of ionomer for electrochemical cell applications are discussed.

### BACKGROUND

Electrochemical devices, including fuel cells and electrolysis cells, typically contain a unit referred to as a membrane electrode assembly (MEA). Such MEA's comprise one or more electrode portions, which include a catalytic electrode material such as, for example, Pt or Pd, in contact with an ion-conductive membrane. Polymer electrolyte membranes (PEMs) are used in electrochemical cells as solid electrolytes. In a typical electrochemical cell, a PEM is in contact with cathode and anode electrodes, and transports ions formed at the anode to the cathode, allowing a current of electrons to flow in an external circuit connecting the electrodes. PEMs also find use in chlor-alkali cells wherein brine mixtures are separated to form chlorine gas and sodium hydroxide. The membrane selectively transports sodium cations while rejecting chloride anions.

### SUMMARY

Typically, electrochemical cells have a given lifetime. This lifetime is usually dictated by various components within the cell including the polymer electrolyte membrane. Measuring difference between the open circuit voltage (or OCV) of the polymer electrolyte membrane after extended use can be used to identify those membrane that have improved lifetimes when operated under higher temperature conditions. The present disclosure has discovered that the use of high surface area lithium fluoride provides improved electrochemical durability of a polymer electrolyte membrane.

In one aspect, the present disclosure provides a composite including a fluorinated polymer and nanoparticles of lithium fluoride having an average BET surface area of at least 10 m²/g. The fluorinated polymer includes a fluorinated polymer backbone chain and a plurality of groups represented by formula —SO₂X, in which each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′, or —OZ, and Z is independently a hydrogen, an alkali-metal cation, or a quaternary ammonium cation, X′ is independently —NZH or —OZ, and each d is independently 1 to 6.

In another aspect, the present disclosure provides a composite including a fluorinated polymer and nanoparticles of lithium fluoride having an average BET surface area of at least 10 m²/g. The fluorinated polymer includes a fluorinated polymer backbone chain and a plurality of groups represented by formula-SO₂X, in which each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′, or —OZ, and Z is independently a hydrogen, an alkali-metal cation, or a quaternary ammonium cation, X′ is independently —NZH or —OZ, and each d is independently 1 to 6.

In some embodiments, at least some of the plurality of the groups represented by formula —SO₂X are part of the side chains pendent from the fluorinated polymer backbone. These side chains are represented by formula: —Rp-SO₂X, in which Rp is bonded to the fluorinated polymer backbone and is a linear, branched, or cyclic perfluorinated or partially fluorinated alkyl or alkoxy group optionally interrupted by one or more —O— groups.

In some embodiments, the fluorinated polymer includes at least one divalent unit independently represented by formula:

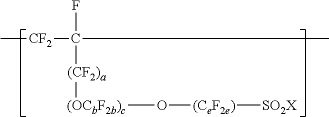

in which a is 0 or 1, each b is independently 2 to 8, c is 0 to 2, e is 1 to 8, and each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′, or —OZ, and Z is independently a hydrogen, an alkali-metal cation, or a quaternary ammonium cation, X′ is independently —NZH or —OZ, and each d is independently 1 to 6.

In another aspect, the present disclosure provides a polymer electrolyte membrane that includes the composite of the present disclosure.

In another aspect, the present disclosure provides a catalyst ink that includes the composite of the present disclosure.

In another aspect, the present disclosure provides an electrode that includes the composite of the present disclosure and an electroactive catalyst.

In another aspect, the present disclosure provides a membrane electrode assembly that includes the composite of the present disclosure in the proton exchange membrane, the electrode, or both.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms.

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Alkylene” is the multivalent (e.g., divalent or trivalent) form of the “alkyl” groups defined above. “Arylene” is the multivalent (e.g., divalent or trivalent) form of the “aryl” groups defined above.

“Arylalkylene” refers to an “alkylene” moiety to which an aryl group is attached. “Alkylarylene” refers to an “arylene” moiety to which an alkyl group is attached.

The terms “perfluoro” and “perfluorinated” refer to groups in which all C—H bonds are replaced by C—F bonds.

The phrase “interrupted by at least one —O— group”, for example, with regard to a perfluoroalkyl or perfluoroalkylene group refers to having part of the perfluoroalkyl or perfluoroalkylene on both sides of the —O— group. For example, —CF₂CF₂—O—CF₂—CF₂— is a perfluoroalkylene group interrupted by an —O— group.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a plot of current density versus potential for Example 1 and Comparative Example 1 at 80° C.

FIG. 2 is a plot of current density versus potential for Example 1 and Comparative Example 1 at 130° C.

FIG. 3 is a scanning electron micrograph of Filler A.

FIG. 4 is a scanning electron micrograph of Filler B.

FIG. 5 is a scanning electron micrograph of a cross section of the composite membrane of Comparative Example 2.

FIG. 6 is a scanning electron micrograph of a cross section of the composite membrane of Example 1.

### DETAILED DESCRIPTION

Polymer electrolyte membranes require the presence of water for conductivity. When typical membranes are exposed to conditions of low humidity and/or high temperatures (e.g. temperatures above about 90° C.), their resistance increases, and their proton conductivity decreases. However, in many industrial applications (e.g., in fuel cells) exposure to high temperatures and/or low humidity is required. Excessive cooling of the cell system is necessary for maintaining satisfactory proton conductivity, which leads to increasing operating costs and presents an economic disadvantage. Typically, and advantageously, membranes made from the composites of the present disclosure maintain a satisfactory level of cation-conductivity, in particular proton-conductivity, even at high temperatures and/or low humidity. Operation at temperatures above about 90° C. or above about 100° C. ensure a higher CO-tolerance and a reduction of the Pt-catalysts, and the overall system costs of a fuel-cell stack would be reduced.

The composite and membrane of the present disclosure includes at least one fluorinated polymer and nanoparticles of lithium fluoride. Without requiring a uniform dispersion, it should be understood that the nanoparticles are dispersed within a matrix of the fluorinated polymer. That is, the nanoparticles will generally be found within the bulk of the fluorinated polymer.

The composite and membrane of the present disclosure includes at least one fluorinated polymer. The fluorinated polymer has a fluorinated polymer backbone chain and a plurality of —SO₂X groups, useful for providing ionic conductivity to the fluoropolymer. The —SO₂X groups may be terminal groups on the fluorinated polymer backbone or may be part of one or more pendent groups.

In the fluorinated polymer, each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′ (in which each d is independently 1 to 6, 1 to 4, or 2 to 4), or —OZ. In some embodiments, X is —NZH or —OZ. In some embodiments, X is —OZ. In some embodiments, X is independently —NZH, —NZSO₂(CF₂)₁₋₆SO₂X′, or —NZ[SO₂(CF₂)_{d}SO₂NZ]₁₋₁₀SO₂(CF₂)_{d}SO₂X′. X′ is independently —NZH or —OZ (in some embodiments, —OZ). In any of these embodiments, each Z is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z is an alkali-metal cation. In some embodiments, Z is a sodium or lithium cation. In some embodiments, Z is a sodium cation.

In some embodiments, at least some of the plurality of the groups represented by formula —SO₂X are part of the side chains pendent from the fluorinated polymer backbone. In some embodiments, the side chains are represented by formula —Rp-SO₂X, in which X is as defined above in any of its embodiments, and Rp is bonded to the fluorinated polymer backbone and is a linear, branched, or cyclic perfluorinated or partially fluorinated alkyl or alkoxy group optionally interrupted by one or more —O— groups. Rp may typically comprise from 1 to 15 carbon atoms and from 0 to 4 oxygen atoms. The side chains may be derived from perfluorinated olefins, perfluorinated allyl ethers, or perfluorinated vinyl ethers bearing an —SO₂X group or precursor, wherein the precursor groups may be subsequently converted into —SO₂X groups.

Examples of suitable]-Rp groups include:
]—(CF₂)_{e′}— where e′ is 1, 2, 3, 4, 5, 6, 7, 8, 9, 10, 11, 12, 13, 14 or 15;
]—(CF₂CF(CF₃))_{e′}— where e′ is 1, 2, 3, 4, or 5;
]—(CF(CF₃)CF₂)_{e′}— where e′ is 1, 2, 3, 4, or 5;
]—(CF₂CF(CF₃)—)_{e′}—CF₂— where e′ is 1, 2, 3 or 4;
]—(CF₂)₀₋₁—(O—CF₂CF₂—)_{c′} where c′ is 1, 2, 3, 4, 5, 6 or 7;
]—(CF₂)₀₋₁—(O—CF₂CF₂CF₂—)_{c′} where c′ is 1, 2, 3, 4, or 5;
]—(CF₂)₀₋₁—(O—CF₂CF₂CF₂CF₂—)_{c′} where c′ is 1, 2 or 3;
]—(CF₂)₀₋₁—(O—CF₂CF(CF₃)—)_{c′} where c′ is 1, 2, 3, 4, or 5;
]—(CF₂)₀₋₁—(O—CF(CF₃)CF₂—)_{c′} where c′ is 1, 2, 3, 4 or 5;
]—(CF₂)₀₋₁—(O—CF(CF₂CF₃)CF₂—)_{c′} where c′ is 1, 2 or 3;
]—(CF₂)₀₋₁—(O—CF₂CF(CF₃)—)_{c′}—O—(CF₂)_{e′}— where c′ is 1, 2, 3 or 4 and e′ is 1 or 2;
]—(CF₂)₀₋₁—(O—CF₂CF(CF₂CF₃)—)_{c′}—O—(CF₂)_{e′}— where c′ is 1, 2 or 3 and e′ is 1 or 2;
]—(CF₂)₀₋₁—(O—CF(CF₃)CF₂)_{c′}—O(CF₂)_{e′}— where c′ is 1, 2, 3 or 4 and e′ is 1 or 2;
]—(CF₂)₀₋₁—(O—CF(CF₂CF₃)CF₂—)_{c′}—O—(CF₂)_{e′}— where c′ is 1, 2 or 3 and e′ is 1 or 2;
]—(CF₂)₀₋₁—O—(CF₂)_{e′}— where e′ is 1, 2, 3, 4, 5, 6, 7, 8, 9, 10, 11, 12, 13 or 14; and
]—(CF₂)₀₋₁—O—CF₂—CF(O(CF₂)_{e′}—)CF₃ where e′ is 1, 2 or 3.

In some embodiments, the side chains pendent from the fluoropolymer backbone chain comprise at least one of —(CF₂)₀₋₁—O(CF₂)_{e′}SO₂X with e′ being 1, 2, 3, 4 or 5, —(CF₂)₀₋₁—O(CF₂)₄SO₂X, —(CF₂)₀₋₁—OCF₂CF(CF₃)OCF₂CF₂SO₂X, or —(CF₂)₀₋₁—O—CF₂—CF(OCF₂CF₂SO₂X)CF₃, wherein X is as defined above in any of its embodiments. In some embodiments, X is —OZ, wherein Z is H+, Li+, Na+, or K+.

Side chains pendent from the fluoropolymer backbone may be introduced by copolymerizing the corresponding sulfonyl-group containing monomers (in some embodiments, sulfonyl fluoride monomers) or by grafting the side groups to the backbone as described in U.S. Pat. No. 6,423,784 (Hamrock et al.). Suitable corresponding monomers include those according to the formula above where “]-” is replaced with “CZ₂═CZ—”, wherein Z is F or H. The sulfonyl fluoride monomers may be synthesized by standard methods, such as methods disclosed in U.S. Pat. No. 6,624,328 (Guerra et al.) and the references cited therein and the methods described below. The Rp-SO₂F groups of the sulfonyl fluoride monomers generally define the pendent groups of the resulting fluoropolymer after the polymerization.

In some embodiments, the fluorinated polymer useful in the composite of the present disclosure includes divalent units represented by formula —[CF₂—CF₂]—. In some embodiments, the fluorinated polymer comprises at least 60 mole % of divalent units represented by formula —[CF₂—CF₂]—, based on the total moles of divalent units. In some embodiments, the fluorinated polymer comprises at least 65, 70, 75, 80, or 90 mole % of divalent units represented by formula —[CF₂—CF₂]—, based on the total moles of divalent units. Divalent units represented by formula —[CF₂—CF₂]— are incorporated into the copolymer by copolymerizing components including tetrafluoroethylene (TFE). In some embodiments, the components to be polymerized include at least 60, 65, 70, 75, 80, or 90 mole % TFE, based on the total moles of components to be polymerized.

In some embodiments, the fluorinated polymer useful in the composite of the present disclosure includes at least one divalent unit independently represented by formula:

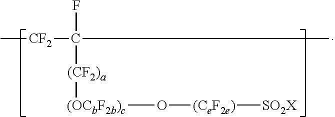

In this formula, a is 0 or 1, b is a number from 2 to 8, c is a number from 0 to 2, and e is a number from 1 to 8. In some embodiments, b is a number from 2 to 6 or 2 to 4. In some embodiments, b is 2. In some embodiments, e is a number from 1 to 6 or 2 to 4. In some embodiments, e is 2. In some embodiments, e is 4. In some embodiments, c is 0 or 1. In some embodiments, c is 0. In some embodiments, c is 0, and e is 2 or 4. In some embodiments, c is 0, and e is 3 to 8, 3 to 6, 3 to 4, or 4. In some embodiments, at least one of c is 1 or 2 or e is 3 to 8, 3 to 6, 3 to 4, or 4. In some embodiments, when a and c are 0, then e is 3 to 8, 3 to 6, 3 to 4, or 4. In some embodiments, b is 3, c is 1, and e is 2. In some embodiments, b is 2 or 3, c is 1, and e is 2 or 4. In some embodiments, a, b, c, and e may be selected to provide greater than 2, at least 3, or at least 4 carbon atoms. CₑF₂ₑ may be linear or branched. In some embodiments, CₑF₂ₑ can be written as (CF₂)ₑ, which refers to a linear perfluoroalkylene group. When c is 2, the b in the two C_{b}F_{2b} groups may be independently selected. However, within a C_{b}F_{2b} group, a person skilled in the art would understand that b is not independently selected. Also in this formula and in any —SO₂X end groups that may be present, X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′ (in which each d is independently 1 to 6, 1 to 4, or 2 to 4), or —OZ. In some embodiments, X is —NZH or —OZ. In some embodiments, X is —OZ. In some embodiments, X is independently —NZH, —NZSO₂(CF₂)₁₋₆SO₂X′, or —NZ[SO₂(CF₂)_{d}SO₂NZ]₁₋₁₀SO₂(CF₂)_{d}SO₂X′. X′ is independently —NZH or —OZ (in some embodiments, —OZ). In any of these embodiments, each Z is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z is an alkali-metal cation. In some embodiments, Z is a sodium or lithium cation. In some embodiments, Z is a sodium cation.

Fluorinated polymers having divalent units represented by this formula can be prepared by copolymerizing components including at least one polyfluoroallyloxy or polyfluorovinyloxy compound represented by formula CF₂═CF(CF₂)ₐ—(OC_{b}F_{2b})_{c}—O—(CₑF₂ₑ)—SO₂X″, in which a, b, c, and e are as defined above in any of their embodiments, and each X″ is independently —F, —NZH, or —OZ. Suitable polyfluoroallyloxy and polyfluorovinyloxy compounds of this formula include CF₂═CFCF₂—O—CF₂—SO₂X″, CF₂═CFCF₂—O—CF₂CF₂—SO₂X″, CF₂═CFCF₂—O—CF₂CF₂CF₂—SO₂X″, CF₂═CFCF₂—O—CF₂CF₂CF₂CF₂—SO₂X″, CF₂═CFCF₂—O—CF₂CF(CF₃)—O—(CF₂)ₑ—SO₂X″, CF₂═CF—O—CF₂—SO₂X″, CF₂═CF—O—CF₂CF₂—SO₂X″, CF₂═CF—O—CF₂CF₂CF₂—SO₂X″, CF₂═CF—O—CF₂CF₂CF₂CF₂—SO₂X″, and CF₂═CF—O—CF₂—CF(CF₃)—O—(CF₂)ₑ—SO₂X″. In some embodiments, the compound represented by formula CF₂═CF(CF₂)ₐ—(OC_{b}F_{2b})_{c}—O—(CₑF₂ₑ)—SO₂X″ is CF₂═CFCF₂—O—CF₂CF₂—SO₂X″, CF₂═CF—O—CF₂CF₂—SO₂X″, CF₂═CFCF₂—O—CF₂CF₂CF₂CF₂—SO₂X″, or CF₂═CF—O—CF₂CF₂CF₂CF₂—SO₂X″. In some embodiments, the compound represented by formula CF₂═CF(CF₂)ₐ—(OC_{b}F_{2b})_{c}—O—(CₑF₂ₑ)—SO₂X″ is CF₂═CFCF₂—O—CF₂CF₂—SO₂X″, CF₂═CFCF₂—O—CF₂CF₂CF₂CF₂—SO₂X″, or CF₂═CF—O—CF₂CF₂CF₂CF₂—SO₂X″. In some embodiments, the compound represented by formula CF₂═CF(CF₂)ₐ—(OC_{b}F_{2b})_{c}—O—(CₑF₂ₑ)—SO₂X″ is CF₂═CFCF₂—O—CF₂CF₂—SO₂X″ or CF₂═CFCF₂—O—CF₂CF₂CF₂CF₂—SO₂X″.

Compounds represented by formula CF₂═CF(CF₂)ₐ—(OC_{b}F_{2b})_{c}—O—(CₑF₂ₑ)—SO₂X″ can be made by known methods. For example acid fluorides represented by formula FSO₂(CF₂)ₑ₋₁—C(O)F or FSO₂(CF₂)ₑ—(OC_{b}F_{2b})_{c-1}—C(O)F can be reacted with perfluoroallyl chloride, perfluoroallyl bromide, or perfluoroallyl fluorosulfate in the presence of potassium fluoride as described in U.S. Pat. No. 4,273,729 (Krespan) to make compounds of formula CF₂═CFCF₂—(OC_{b}F_{2b})_{c}—O—(CₑF₂ₑ)—SO₂F. Compounds of formula CF₂═CFCF₂—(OC_{b}F_{2b})_{c}—O—(CₑF₂ₑ)—SO₂F can be hydrolyzed with a base (e.g., alkali metal hydroxide or ammonium hydroxide) to provide a compound represented by formula CF₂═CFCF₂—(OC_{b}F_{2b})_{c}—O—(CₑF₂ₑ)—SO₃Z.

In some embodiments of the fluorinated polymer useful in the composite of the present disclosure, at least some of the fluorinated divalent units are derived from at least one short-chain SO₂X″-containing vinyl ether monomer. Short-chain SO₂X″-containing vinyl ether monomers represented by formula CF₂═CF—O—(CF₂)₂—SO₂X″ (e.g., those represented by formula [CF₂═CF—O—(CF₂)₂—SO₃]M, where M is an alkali metal, and CF₂═CF—O—(CF₂)₂—SO₂NZH) can be made by known methods. Conveniently, a compound of formula [CF₂═CF—O—(CF₂)₂—SO₃]M can be prepared in three steps from the known compound represented by formula FC(O)—CF(CF₃)—O—(CF₂)₂—SO₂F. As reported in Gronwald, O., et al; “Synthesis of difluoroethyl perfluorosulfonate monomer and its application”; J. Fluorine Chem., 2008, 129, 535-540, the acid fluoride can be combined with a methanol solution of sodium hydroxide to form the disodium salt, which can be dried and heated in dry diglyme to effect the carboxylation.

FC(O)—CF(CF₃)—O—(CF₂)₂—SO₂F can be prepared by ring-opening and derivatization of tetrafluoroethane-β-sultone as described in U.S. Pat. No. 4,962,292 (Marraccini et al.). Compounds represented by formula CF₂═CF—O—(CF₂)ₐ—SO₂X″ can also be prepared by hydrolyzing the products from the elimination of halogen from a compound of formula CF₂Cl—CFCl—O—(CF₂)₂—SO₂F described in U.S. Pat. No. 6,388,139 (Resnick) and or hydrolyzing the products of decarboxylation of (FSO₂—(CF₂)₃₋₄—O—CF(CF₃)—COO⁻)ₚM^{+p} described in U.S. Pat. No. 6,624,328 (Guerra). Compounds of formula CF₂═CF—O—(CF₂)₂—SO₂NH₂ can be prepared, for example, by reaction of a cyclic sulfone with one equivalent of LHMDS as described by Uematsu, N., et al. “Synthesis of novel perfluorosulfonamide monomers and their application”; J. Fluorine Chem., 2006, 127, 1087-1095.

In some embodiments of the fluorinated polymer useful in the composite of the present disclosure, the fluorinated polymer includes divalent units represented by formula

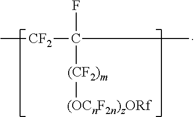

In this formula Rf is a linear or branched perfluoroalkyl group having from 1 to 8 carbon atoms and optionally interrupted by one or more —O— groups, z is 0, 1 or 2, each n is independently from 1 to 4, and m is 0 or 1. In some embodiments, n is 1, 3, or 4, or from 1 to 3, or from 2 to 3, or from 2 to 4. In some embodiments, when z is 2, one n is 2, and the other is 1, 3, or 4. In some embodiments, when a is 1 in any of the formulas described above, for example, n is from 1 to 4, 1 to 3, 2 to 3, or 2 to 4. In some embodiments, n is 1 or 3. In some embodiments, n is 1. In some embodiments, n is not 3. When z is 2, the n in the two CₙF₂ₙ groups may be independently selected. However, within a CₙF₂ₙ group, a person skilled in the art would understand that n is not independently selected. CₙF₂ₙ may be linear or branched. In some embodiments, CₙF₂ₙ is branched, for example, —CF₂—CF(CF₃)—. In some embodiments, CₙF₂ₙ can be written as (CF₂)ₙ, which refers to a linear perfluoroalkylene group. In these cases, the divalent units of this formula are represented by formula

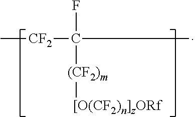

In some embodiments, CₙF₂ₙ is —CF₂—CF₂—CF₂—.

In some embodiments, (OCₙF₂ₙ)_{z} is represented by —O—(CF₂)₁₋₄—[O(CF₂)₁₋₄]₀₋₁. In some embodiments, Rf is a linear or branched perfluoroalkyl group having from 1 to 8 (or 1 to 6) carbon atoms that is optionally interrupted by up to 4, 3, or 2 —O— groups. In some embodiments, Rf is a perfluoroalkyl group having from 1 to 4 carbon atoms optionally interrupted by one —O— group. In some embodiments, z is 0, m is 0, and Rf is a linear or branched perfluoroalkyl group having from 1 to 4 carbon atoms. In some embodiments, z is 0, m is 0, and Rf is a branched perfluoroalkyl group having from 3 to 8 carbon atoms. In some embodiments, m is 1, and Rf is a branched perfluoroalkyl group having from 3 to 8 carbon atoms or a linear perfluoroalkyl group having 5 to 8 carbon atoms. In some embodiments, Rf is a branched perfluoroalkyl group having from 3 to 6 or 3 to 4 carbon atoms. An example of a useful perfluoroalkyl vinyl ether (PAVE) from which these divalent units in which m and z are 0 are derived is perfluoroisopropyl vinyl ether (CF₂═CFOCF(CF₃)₂), also called iso-PPVE. Other useful PAVEs include perfluoromethyl vinyl ether, perfluoroethyl vinyl ether, and perfluoropropyl vinyl ether.

Divalent units represented by formulas

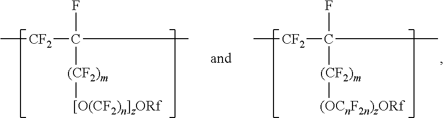

in which m is 0, typically arise from perfluoroalkoxyalkyl vinyl ethers. Suitable perfluoroalkoxyalkyl vinyl ethers (PAOVE) include those represented by formula CF₂═CF[O(CF₂)ₙ]_{z}ORf and CF₂═CF(OCₙF₂ₙ)_{z}ORf, in which n, z, and Rf are as defined above in any of their embodiments. Examples of suitable perfluoroalkoxyalkyl vinyl ethers include CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃ CF₂═CFOCF₂CF₂OCF₂CF₂OCF₂CF₂CF₃, CF₂═CFOCF₂CF(CF₃)—O—C₃F₇(PPVE-2), CF₂═CF(OCF₂CF(CF₃))₂—O—C₃F₇(PPVE-3), and CF₂═CF(OCF₂CF(CF₃))₃—O—C₃F₇(PPVE-4). In some embodiments, the perfluoroalkoxyalkyl vinyl ether is selected from CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, and combinations thereof. Many of these perfluoroalkoxyalkyl vinyl ethers can be prepared according to the methods described in U.S. Pat. No. 6,255,536 (Worm et al.) and U.S. Pat. No. 6,294,627 (Worm et al.). In some embodiments, the PAOVE is perfluoro-3-methoxy-n-propyl vinyl ether.

The divalent units represented by formula

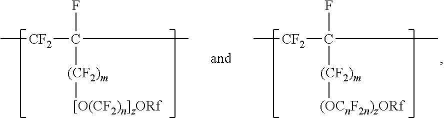

which m is 1, are typically derived from at least one perfluoroalkoxyalkyl allyl ether. Suitable perfluoroalkoxyalkyl allyl ethers include those represented by formula CF₂═CFCF₂(OCₙF₂n)_{z}ORf, in which n, z, and Rf are as defined above in any of their embodiments. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. In some embodiments, the perfluoroalkoxyalkyl allyl ether is selected from CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, and combinations thereof.

Many of these perfluoroalkoxyalkyl allyl ethers can be prepared, for example, according to the methods described in U.S. Pat. No. 4,349,650 (Krespan). Perfluoroalkoxyalkyl allyl ethers can also be prepared by combining first components comprising at least one of CF₂═CF—CF₂—OSO₂Cl or CF₂═CF—CF₂—OSO₂CF₃, a polyfluorinated compound comprising at least one ketone or carboxylic acid halide or combination thereof, and fluoride ion. Polyfluorinated compounds comprising at least one ketone or carboxylic acid halide or combination thereof and fluoride ions can be any of those described, for example, in U.S. Pat. No. 4,349,650 (Krespan). CF₂═CF—CF₂—OSO₂Cl can conveniently be prepared by reaction of boron trichloride (BCl₃) and ClSO₃H to provide B(OSO₂Cl)₃ and subsequently reacting the B(OSO₂Cl)₃ and hexafluoropropylene (HFP) as described in Int. Pat. Appl. Pub. No. WO 2018/211457 (Hintzer et al.). Combining components comprising M(OSO₂CF₃)₃ and hexafluoropropylene (HFP) provides CF₂═CF—CF₂—OSO₂CF₃, wherein M is Al or B. Al(OSO₂CF₃)₃ is commercially available, for example, from chemical suppliers such as abcr GmbH (Karlsruhe, Germany) and Sigma-Aldrich (St. Louis, Missouri). Reaction of BCl₃ and CF₃SO₃H can be useful to provide B(OSO₂CF₃)₃. Further details about the preparation of CF₂═CF—CF₂—OSO₂CF₃ can be found in Int. Pat. Appl. Pub. No. WO 2018/211457 (Hintzer et al.).

The vinyl ethers and allyl ethers described above in any of their embodiments, may be present in the components to be polymerized in any useful amount, in some embodiments, in an amount of up to 20, 15, 10, 7.5, or 5 mole percent, at least 3, 4, 4.5, 5, or 7.5 mole percent, or in a range from 3 to 20, 4 to 20, 4.5 to 20, 5 to 20, 7.5 to 20, or 5 to 15 mole percent, based on the total amount of polymerizable components. Accordingly, the fluorinated polymer useful in the composite of the present disclosure can include divalent units derived from these vinyl ethers and allyl ethers in any useful amount, in some embodiments, in an amount of up to 20, 15, 10, 7.5, or 5 mole percent, at least 3, 4, 4.5, 5, or 7.5 mole percent, or in a range from 3 to 20, 4 to 20, 4.5 to 20, 5 to 20, 7.5 to 20, or 5 to 15 mole percent, based on the total moles of divalent units. In some embodiments, fluorinated polymers useful in the composite of the present disclosure are free of divalent units represented by formula

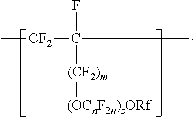

Fluorinated polymers including divalent units represented by formula

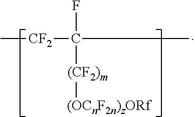

in any of the embodiments described above can be easier to disperse than comparative fluorinated polymers that does not have these divalent units but is otherwise identical. A technique that can be useful for dispersing a fluoropolymer in a desired medium is up-concentration of a dilute dispersion of fluoropolymer. For example, U.S. Pat. Appl. Pub. No. 2017/0183435 (Ino) reports preparing a fluoropolymer electrolyte solution by heating a solid fluoropolymer electrolyte in a solution of 50% by weight solution of ethanol in water in an autoclave at 160° C. with stirring for five hours to achieve a fluoropolymer electrolyte solution with a solids concentration of 5% by weight. Concentration under reduced pressure provided a fluoropolymer electrolyte solution with a solids concentration of 20% by weight. By contrast, a fluorinated polymer having ether-containing divalent units can typically be directly dispersed at a concentration of at least 10, 15, 20, or 25 percent by weight in a solution of water and organic solvent without the need for up-concentrating. In some embodiments, the copolymer disclosed herein can be directly dispersed at a concentration of up to 30, 40, or 50 percent by weight in a solution of water and organic solvent without the need for up-concentrating.

In some embodiments of the fluorinated polymer useful in the composite of the present disclosure, the fluorinated polymer includes divalent units derived from at least one fluorinated olefin independently represented by formula C(R)₂═CF—Rf₂. These fluorinated divalent units are represented by formula —[CR₂—CFRf₂]—. In formulas C(R)₂═CF—Rf₂ and —[CR₂—CFRf₂]—, Rf₂ is fluorine or a perfluoroalkyl having from 1 to 8, in some embodiments 1 to 3, carbon atoms, and each R is independently hydrogen, fluorine, or chlorine. Some examples of fluorinated olefins useful as components of the polymerization include, hexafluoropropylene (HFP), trifluorochloroethylene (CTFE), and partially fluorinated olefins (e.g., vinylidene fluoride (VDF), tetrafluoropropylene (R1234yf), pentafluoropropylene, and trifluoroethylene). In some embodiments, the fluoropolymer includes at least one of divalent units derived from chlorotrifluoroethylene or divalent units derived from hexafluoropropylene. Divalent units represented by formula —[CR₂—CFRf₂]— may be present in the copolymer in any useful amount, in some embodiments, in an amount of up to 10, 7.5, or 5 mole percent, based on the total moles of divalent units.

In some embodiments of the fluorinated polymer useful in the composite of the present disclosure, the copolymer is essentially free of VDF units, and the components to be copolymerized are essentially free of VDF. For example, at a pH higher than 8, VDF may undergo dehydrofluorination, and it may be useful to exclude VDF from the components to be polymerized. “Essentially free of VDF” can mean that VDF is present in the components to be polymerized at less than 1 (in some embodiments, less than 0.5, 0.1, 0.05, or 0.01) mole percent. “Essentially free of VDF” includes being free of VDF.

Fluorinated polymers useful for the composite of the present disclosure can comprise divalent units independently represented by formula:

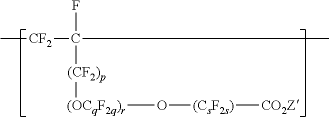

wherein p is 0 or 1, q is 2 to 8, r is 0 to 2, s is 1 to 8, and Z′ is a hydrogen, an alkali-metal cation, or a quaternary ammonium cation. In some embodiments, q is a number from 2 to 6 or 2 to 4. In some embodiments, q is 2. In some embodiments, s is a number from 1 to 6 or 2 to 4. In some embodiments, s is 2. In some embodiments, s is 4. In some embodiments, r is 0 or 1. In some embodiments, r is 0. In some embodiments, r is 0, and s is 2 or 4. In some embodiments, q is 3, r is 1, and s is 2. CₛF₂ₛ may be linear or branched. In some embodiments, CₛF₂ₛ can be written as (CF₂)ₛ, which refers to a linear perfluoroalkylene group. When r is 2, the q in the two C_{q}F_{2q} groups may be independently selected. However, within a C_{q}F_{2q} group, a person skilled in the art would understand that q is not independently selected. Each Z′ is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z′ is an alkali-metal cation. In some embodiments, Z′ is a sodium or lithium cation. In some embodiments, Z′ is a sodium cation. Divalent units represented by formula

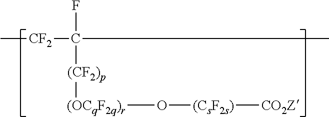

may be present in the fluorinated polymer in any useful amount, in some embodiments, in an amount of up to 10, 7.5, or 5 mole percent, based on the total moles of divalent units.

Fluorinated polymers useful in the composite of the present disclosure can also include units derived from bisolefins represented by formula X₂C═CY′—(CW₂)ₘ—(O)ₙ—R_{F}—(O)ₒ—(CW₂)ₚ—CY′═CX₂. In this formula, each of X, Y′, and W is independently fluoro, hydrogen, alkyl, alkoxy, polyoxyalkyl, perfluoroalkyl, perfluoroalkoxy or perfluoropolyoxyalkyl, m and p are independently an integer from 0 to 15, and n, o are independently 0 or 1. In some embodiments, X, Y′, and W are each independently fluoro, CF₃, C₂F₅, C₃F₇, C₄F₉, hydrogen, CH₃, C₂H₅, C₃H₇, C₄H₉. In some embodiments, X, Y′, and W are each fluoro (e.g., as in CF₂═CF—O—R_{F}—O—CF═CF₂ and CF₂═CF—CF₂—O—R_{F}—O—CF₂—CF═CF₂). In some embodiments, n and o are 1, and the bisolefins are divinyl ethers, diallyl ethers, or vinyl-allyl ethers. R_{F} represents linear or branched perfluoroalkylene or perfluoropolyoxyalkylene or arylene, which may be non-fluorinated or fluorinated. In some embodiments, R_{F} is perfluoroalkylene having from 1 to 12, from 2 to 10, or from 3 to 8 carbon atoms. The arylene may have from 5 to 14, 5 to 12, or 6 to 10 carbon atoms and may be non-substituted or substituted with one or more halogens other than fluoro, perfluoroalkyl (e.g. —CF₃ and —CF₂CF₃), perfluoroalkoxy (e.g. —O—CF₃, —OCF₂CF₃), perfluoropolyoxyalkyl (e.g., —OCF₂OCF₃; —CF₂OCF₂OCF₃), fluorinated, perfluorinated, or non-fluorinated phenyl or phenoxy, which may be substituted with one or more perfluoroalkyl, perfluoroalkoxy, perfluoropolyoxyalkyl groups, one or more halogens other than fluoro, or combinations thereof. In some embodiments, R_{F} is phenylene or mono-, di-, tri- or tetrafluoro-phenylene, with the ether groups linked in the ortho, para or meta position. In some embodiments, R_{F} is CF₂; (CF₂)_{q} wherein q is 2, 3, 4, 5, 6, 7 or 8; CF₂—O—CF₂; CF₂—O—CF₂—CF₂; CF(CF₃)CF₂; (CF₂)₂—O—CF(CF₃)—CF₂; CF(CF₃)—CF₂—O—CF(CF₃)CF₂; or (CF₂)₂—O—CF(CF₃)—CF₂—O—CF(CF₃)—CF₂—O—CF₂. The bisolefins can introduce long chain branches as described in U.S. Pat. Appl. Pub. No. 2010/0311906 (Lavallde et al.). The bisolefins, described above in any of their embodiments, may be present in the components to be polymerized in any useful amount, in some embodiments, in an amount of up to 2, 1, or 0.5 mole percent and in an amount of at least 0.1 mole percent, based on the total amount of polymerizable components.

Fluorinated polymers useful in the composite of the present disclosure can also include units derived from non-fluorinated monomers. Examples of suitable non-fluorinated monomers include ethylene, propylene, isobutylene, ethyl vinyl ether, vinyl benzoate, ethyl allyl ether, cyclohexyl allyl ether, norbornadiene, crotonic acid, an alkyl crotonate, acrylic acid, an alkyl acrylate, methacrylic acid, an alkyl methacrylate, and hydroxybutyl vinyl ether. Any combination of these non-fluorinated monomers may be useful. In some embodiments, the components to be polymerized further include acrylic acid or methacrylic acid, and the copolymer of the present disclosure includes units derived from acrylic acid or methacrylic acid.

Typically, the fluorinated polymer useful for the composite of the present disclosure does not include cyclic structures comprising fluorinated carbon atoms in the main chain (that is, divalent units comprising such cyclic structures) such as derived from perfluorinted dioxoles and dioxolanes, including those described in 2013/0253157 (Takami), 2013/0245219 (Perry), and 2013/0252134 (Takami), and U.S. Pat. No. 8,470,943 (Watakabe).

In some embodiments, the fluorinated polymer useful in the composite of the present disclosure can be made from the sulfonyl fluoride compounds, where X in any of the aforementioned compounds represented by formula CF₂═CF(CF₂)ₐ—(OC_{b}F_{2b})_{c}—O—(CₑF₂ₑ)—SO₂X is F, according to the methods described below, for example. Hydrolysis of a copolymer having —SO₂F groups with an alkaline hydroxide (e.g. LiOH, NaOH, or KOH) solution provides —SO₃Z groups, which may be subsequently acidified to SO₃H groups. Treatment of a copolymer having —SO₂F groups with water and steam can form SO₃H groups. Thus, copolymers having —SO₂F groups (that is, in which X is F) are useful intermediates for making fluorinated polymers useful in the composite of the present disclosure.

In some embodiments, the fluorinated polymer useful in the composite of the present disclosure can be made by a method that includes copolymerizing components including at least one compound represented by formula CF₂═CF(CF₂)ₐ—(OC_{b}F_{2b})_{c}—O—(CₑF₂ₑ)—SO₂X′, b, c, and e are as defined above in any of their embodiments. In this formula, X′ is —NZ′H or —OZ′, wherein each Z′ is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z′ is an alkali-metal cation. In some embodiments, Z′ is a sodium or lithium cation. In some embodiments, Z′ is a sodium cation. In some embodiments, the compound represented by formula CF₂═CF(CF₂)ₐ—(OC_{b}F_{2b})_{c}—O—(CF₂ₑ)—SO₂X′ is CF₂═CFCF₂—O—CF₂CF₂—SO₃Na.

The fluorinated polymer useful in the composite of the present disclosure can have an —SO₂X equivalent weight of up to 1200, 1100, or 1000. In some embodiments, the polymer has an —SO₂X equivalent weight of at least 300, 400, or 500. In some embodiments, the polymer has an —SO₂X equivalent weight in a range from 300 to 1200, 400 to 1000, 300 to 1000, or 500 to 900. In general, the —SO₂X equivalent weight of the fluorinated polymer refers to the weight of the polymer containing one mole of —SO₂X groups, wherein X is as defined above in any of its embodiments. In some embodiments, the —SO₂X equivalent weight of the polymer refers to the weight of the copolymer that will neutralize one equivalent of base. In some embodiments, the —SO₂X equivalent weight of the polymer refers to the weight of the polymer containing one mole of sulfonate groups (i.e., —SO₃—). Decreasing the —SO₂X equivalent weight of the polymer tends to increase proton conductivity in the polymer, but tends to decrease its crystallinity, which may compromise the mechanical properties of the polymer (e.g., tensile strength). Thus, the —SO₂X equivalent weight may be selected based on a balance of the requirements for the electrical and mechanical properties of the fluorinated polymer. In some embodiments, the —SO₂X equivalent weight of the polymer refers to the weight of the polymer containing one mole of sulfonamide groups (i.e., —SO₂NH). Sulfonimide groups (e.g., when X is —NZSO₂(CF₂)₁₋₆SO₂X′ and —NZ[SO₂(CF₂)ₐSO₂NZ]₁₋₁₀SO₂(CF₂)ₐSO₂X′) also function as acid groups that can neutralize base as described in further detail below. The effective equivalent weight of polymers including these groups can be much lower than 1000. Equivalent weight can be calculated from the molar ratio of monomer units in the fluorinated polymer and the molecular mass of the precursor monomer having the —SO₂F group.

The fluorinated polymer useful in the composite of the present disclosure can have up to 30 mole percent of divalent units represented by formula

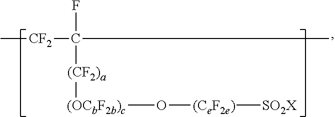

based on the total amount of the divalent units. In some embodiments, the polymer comprises up to 25 or 20 mole percent of these divalent units, based on the total amount of these divalent units. The components that are copolymerized in the methods described herein can comprise up to 30 mole percent of at least one compound represented by formula CF₂═CF(CF₂)ₐ—(OC_{b}F_{2b})_{c}—O—(CₑF₂ₑ)—SO₂X″ or CF₂═CF(CF₂)ₐ—(OC_{b}F_{2b})_{c}—O—(CₑF₂ₑ)—SO₂X′, in any of their embodiments described above, based on the total amount of components that are copolymerized. In some embodiments, the components comprise up to 25 or 20 mole percent of a compound represented by formula CF₂═CF(CF₂)ₐ—(OC_{b}F_{2b})_{c}—O—(CₑF₂ₑ)—SO₂X″ or CF₂═CF(CF₂)ₐ—(OC_{b}F_{2b})_{c}—O—(CₑF₂ₑ)—SO₂X′, based on the total amount of components that are copolymerized.

The molecular weights of fluorinated polymers useful for the composite of the present disclosure can be characterized by the melt viscosity or the melt flow index (MFI, e.g., 265° C./5 kg) of a variation of the copolymer in which X is F. In some embodiments, the fluorinated polymer has an MFI of up to 80 grams per 10 minutes, 70 grams per 10 minutes, 60 grams per 10 minutes, 50 grams per 10 minutes, up to 40 grams per 10 minutes, 30 grams per 10 minutes, or 20 grams per 10 minutes. In some embodiments, the fluorinated polymer has an MFI of up to 15 grams per 10 minutes or up to 12 grams per 10 minutes. When the MFI is up to 80, 70, 60, 50, 40, 30, 20, 15, or 12 grams per 10 minutes, good mechanical properties are achieved. In some embodiments, the fluorinated polymer has an MFI of at least one gram per 10 minutes, 5 grams per 10 minutes, and 10 grams per 10 minutes. The fluorinated polymer can be adjusted to have an MFI of up to 80 grams per 10 minutes by adjusting the amount of the initiator and/or chain-transfer agent used during polymerization, both of which affect the molecular weight and molecular-weight distribution of the copolymer. MFI can also be controlled by the rate and amount of addition of initiator to the polymerization. Variations in the monomer composition can also affect the MFI. It should be noted that an MFI of about 20 grams per 10 minutes measured at 270° C./2.16 kg will give an MFI of 43 grams per 10 minutes measured at 265° C./5 kg. In general, when an MFI is measured at 265° C./5 kg, a value of more than twice than an MFI measured at 270° C./2.16 kg is obtained.

The fluorinated polymer useful in the composite of the present disclosure can be prepared by free-radical polymerization. The radical polymerization may be carried out in a variety of manners, such as in an organic solvent, as an aqueous suspension polymerization, or as an aqueous emulsion polymerization and is described, for example, in U.S. Pat. No. 7,071,271 (Thaler et al.) and U.S. Pat. No. 7,214,740 (Lochhaas et al.). Conveniently, in some embodiments, the method of making the fluorinated polymer disclosed herein includes radical aqueous emulsion polymerization.

A water-soluble initiator (e.g., potassium permanganate or a peroxy sulfuric acid salt) can be useful to start the polymerization process. Salts of peroxy sulfuric acid, such as ammonium persulfate or potassium persulfate, can be applied either alone or in the presence of a reducing agent, such as bisulfites or sulfinates (e.g., fluorinated sulfinates disclosed in U.S. Pat. Nos. 5,285,002 and 5,378,782, both to Grootaert) or the sodium salt of hydroxy methane sulfinic acid (sold under the trade designation “RONGALIT”, BASF Chemical Company, New Jersey, USA). The choice of initiator and reducing agent, if present, will affect the end groups of the copolymer. The concentration range for the initiators and reducing agent can vary from 0.001% to 5% by weight based on the aqueous polymerization medium. —SO₂X end groups can be introduced in the copolymers according to the present disclosure by generating SO₃ radicals during the polymerization process. When salts of peroxy sulfuric acid are used in the presence of a sulfite or bisulfite salt (e.g., sodium sulfite, sodium disulfite, or potassium sulfite), SO₃⁻ radicals are generated during the polymerization process, resulting in —SO₃⁻ end groups. It can be useful to add metal ions to catalyze or accelerate the formation of —SO₃⁻ radicals. By altering the stoichiometry of the sulfite or bisulfite salt versus the peroxy sulfuric acid salt, one can vary the amount of —SO₂X end groups. Disulfites, such as sodium disulfite, may be used with oxidizing agents (e.g., APS, chlorate ions, hypochlorite ions, and bromate ions) to provide —SO₃Z groups on the backbone chain.

The polymerization mixture may also contain additional components, such as buffers, chain-transfer agents, stabilizers, processing aids, and combinations thereof. Chain-transfer agents, such as gaseous hydrocarbon chain-transfer agents, may be used to adjust the molecular weight of the resulting polymer.

A method for making the fluorinated polymer disclosed herein can include copolymerizing components including SO₂F-containing olefins, vinyl, and allyl ethers (e.g., CF₂═CF(CF₂)ₐ—(OC_{b}F_{2b})_{c}—O—(CₑF₂ₑ)—SO₂F), isolating a solid from the polymer dispersion, hydrolyzing the polymer, optionally purifying the polymer by ion exchange purification, and drying the resulting polymer. In some embodiments, the method of making the fluorinated polymer includes copolymerizing components including at least one compound represented by formula CF₂═CF(CF₂)ₐ—(OC_{b}F_{2b})_{c}—O—(CₑF₂ₑ)—SO₂X′, optionally purifying the copolymer by ion-exchange purification, and spray drying the resulting dispersion. This method can conveniently eliminate the steps of isolating solid polymer and hydrolyzing, resulting in a more efficient and cost-effective process.

The components to be polymerized can include more than one compound represented by formula CF₂═CF(CF₂)ₐ—(OC_{b}F_{2b})_{c}—O—(CₑF₂ₑ)—SO₂X′. When more than one compound represented by formula CF₂═CF(CF₂)ₐ—(OC_{b}F_{2b})_{c}—O—(CₑF₂ₑ)—SO₂X′ is present, each of a, b, c, e, and X′ may be independently selected. In some of these embodiments, each X′ is —OZ, in which Z is independently an alkali-metal cation or a quaternary ammonium cation.

Alternatively, a fluorinated polymer useful in the composite of the present disclosure can be made by copolymerizing a compound represented by formula CF₂═CF(CF₂)ₐ—(OC_{b}F_{2b})_{c}—O—(CₑF₂ₑ)—SO₂F and other fluorinated monomers as described above in any of their embodiments. In these embodiments, it is possible to hydrolyze some of the CF₂═CF(CF₂)ₐ—(OC_{b}F_{2b})_{c}—O—(CₑF₂ₑ)—SO₂F (e.g., up to 5 ppm) to obtain an “in situ”-emulsifier as described above.

Most of the initiators described above and any emulsifiers that may be used in the polymerization have an optimum pH-range where they show most efficiency. Also, a pH can be selected for the method according to the present disclosure such that the polymerization is carried out with the salt form of the compound of formula CF₂═CF(CF₂)ₐ—(OC_{b}F_{2b})_{c}—O—(CₑF₂ₑ)—SO₂X′, wherein X′ is an alkali metal cation or an ammonium cation, and to maintain the salt form of the copolymer. For these reasons, buffers may be useful. Buffers include phosphate, acetate, or carbonate (e.g., (NH₄)₂CO₃ or NaHCO₃) buffers or any other acid or base, such as ammonia or alkali-metal hydroxides. In some embodiments, the copolymerizing is carried out at a pH of at least 8, higher than 8, at least 8.5, or at least 9. The concentration range for the initiators and buffers can vary from 0.010% to 5% by weight based on the aqueous polymerization medium. In some embodiments, ammonia is added to the reaction mixture in an amount to adjust the pH to at least 8, higher than 8, at least 8.5, or at least 9.

Typical chain-transfer agents like H₂, lower alkanes, alcohols, ethers, esters, and CH₂Cl₂ may be useful in the preparation of the fluorinated polymer. Termination primarily via chain-transfer results in a polydispersity of about 2.5 or less. A lower polydispersity can sometimes be achieved in the absence of chain-transfer agents. Recombination typically leads to a polydispersity of about 1.5 for small conversions.

Useful polymerization temperatures can range from 20° C. to 150° C. Typically, polymerization is carried out in a temperature range from 30° C. to 120° C., 40° C. to 100° C., or 50° C. to 90° C. The polymerization pressure is usually in the range of 0.4 MPa to 2.5 MPa, 0.6 to 1.8 MPa, 0.8 MPa to 1.5 MPa, and in some embodiments is in the range from 1.0 MPa to 2.0 MPa. Fluorinated monomers such as HFP can be precharged and fed into the reactor as described, for example, in Modern Fluoropolymers, ed. John Scheirs, Wiley & Sons, 1997, p. 241. Perfluoroalkoxyalkyl vinyl ethers represented by formula CF₂═CF(OCₙF₂ₙ)_{z}ORf and perfluoroalkoxyalkyl allyl ethers represented by formula CF₂═CFCF₂(OCₙF₂ₙ)_{z}ORf, wherein n, z, and Rf are as defined above in any of their embodiments, are typically liquids and may be sprayed into the reactor or added directly, vaporized, or atomized.

Conveniently, the polymerization process may be conducted with no emulsifier (e.g., no fluorinated emulsifier). It can be useful to feed the compound represented by formula CF₂═CF(CF₂)ₐ—(OC_{b}F_{2b})_{c}—O—(CₑF₂ₑ)—SO₂X″ and the non-functional comonomers (e.g., perfluoroalkoxyalkyl vinyl or perfluoroalkoxyalkyl allyl ethers or bisolefins) as a homogenous mixture to the polymerization. In some embodiments, it is possible to hydrolyze some of the CF₂═CF(CF₂)ₐ—(OC_{b}F_{2b})—O—(CₑF₂ₑ)—SO₂F (e.g., up to 5 ppm) to obtain an “in situ”-emulsifier. Advantageously, this method may be conducted in the absence of any other fluorinated emulsifiers.

In some embodiments, however, perfluorinated or partially fluorinated emulsifiers may be useful. Generally, these fluorinated emulsifiers are present in a range from about 0.02% to about 3% by weight with respect to the polymer. Polymer particles produced with a fluorinated emulsifier typically have an average diameter, as determined by dynamic light scattering techniques, in range of about 10 nanometers (nm) to about 500 nm, and in some embodiments in range of about 50 nm to about 300 nm. Examples of suitable emulsifiers include perfluorinated and partially fluorinated emulsifier having the formula [R—O-L-COO—]X′ wherein L represents a linear partially or fully fluorinated alkylene group or an aliphatic hydrocarbon group, R_{f} represents a linear partially or fully fluorinated aliphatic group or a linear partially or fully fluorinated aliphatic group interrupted with one or more oxygen atoms, Xⁱ⁺ represents a cation having the valence i and i is 1, 2 or 3. (See, e.g., U.S. Pat. No. 7,671,112 to Hintzer et al.). Additional examples of suitable emulsifiers also include perfluorinated polyether emulsifiers having the formula CF₃—(OCF₂)ₓ—O—CF₂—X′, wherein x has a value of 1 to 6 and X′ represents a carboxylic acid group or salt thereof, and the formula CF₃—O—(CF₂)₃—(OCF(CF₃)—CF₂)_{y}—O-L-Y′ wherein y has a value of 0, 1, 2 or 3, L represents a divalent linking group selected from —CF(CF₃)—, —CF₂—, and —CF₂CF₂—, and Y′ represents a carboxylic acid group or salt thereof (See, e.g., U.S. Pat. Publ. No. 2007/0015865 to Hintzer et al.). Other suitable emulsifiers include perfluorinated polyether emulsifiers having the formula R_{f}—O(CF₂CF₂O)ₓCF₂COOA wherein R_{f} is C_{b}F_{(2b+1)}; where b is 1 to 4, A is a hydrogen atom, an alkali metal or NH₄, and x is an integer of from 1 to 3. (See, e.g., U.S. Pat. Publ. No. 2006/0199898 to Funaki et al.). Suitable emulsifiers also include perfluorinated emulsifiers having the formula F(CF₂)_{b}O(CF₂CF₂O)ₓCF₂COOA wherein A is a hydrogen atom, an alkali metal or NH₄, b is an integer of from 3 to 10, and x is 0 or an integer of from 1 to 3. (See, e.g., U.S. Pat. Publ. No. 2007/0117915 to Funaki et al.). Further suitable emulsifiers include fluorinated polyether emulsifiers as described in U.S. Pat. No. 6,429,258 to Morgan et al. and perfluorinated or partially fluorinated alkoxy acids and salts thereof wherein the perfluoroalkyl component of the perfluoroalkoxy has 4 to 12 carbon atoms, or 7 to 12 carbon atoms. (See, e.g., U.S. Pat. No. 4,621,116 to Morgan). Suitable emulsifiers also include partially fluorinated polyether emulsifiers having the formula [R_{f}—(O)ₜ—CHF—(CF₂)ₓ—COO-]ᵢXⁱ⁺ wherein R_{f} represents a partially or fully fluorinated aliphatic group optionally interrupted with one or more oxygen atoms, t is 0 or 1 and x is 0 or 1, Xⁱ⁺ represents a cation having a valence i and i is 1, 2 or 3. (See, e.g., U.S. Pat. Publ. No. 2007/0142541 to Hintzer et al.). Further suitable emulsifiers include perfluorinated or partially fluorinated ether-containing emulsifiers as described in U.S. Pat. Publ. Nos. 2006/0223924, 2007/0060699, and 2007/0142513 each to Tsuda et al. and 2006/0281946 to Morita et al. Fluoroalkyl, for example, perfluoroalkyl carboxylic acids and salts thereof having 6-20 carbon atoms, such as ammonium perfluorooctanoate (APFO) and ammonium perfluorononanoate (see, e.g., U.S. Pat. No. 2,559,752 to Berry) may also be useful.

If fluorinated emulsifiers are used, the emulsifiers can be removed or recycled from the fluoropolymer latex, if desired, as described in U.S. Pat. No. 5,442,097 to Obermeier et al., U.S. Pat. No. 6,613,941 to Felix et al., U.S. Pat. No. 6,794,550 to Hintzer et al., U.S. Pat. No. 6,706,193 to Burkard et al., and U.S. Pat. No. 7,018,541 to Hintzer et al.

In some embodiments, the obtained fluorinated polymer latices are purified by at least one of anion- or cation-exchange processes to remove functional comonomers, anions, and/or cations before coagulation or spray drying (described below). As used herein, the term “purify” refers to at least partially removing impurities, regardless of whether the removal is complete. Anionic species that may constitute impurities include, for example, fluoride, anionic residues from surfactants and emulsifiers (e.g., perfluorooctanoate), and residual compounds represented by formula CF₂═CF(CF₂)ₐ—(OC_{b}F_{2b})_{c}—O—(CₑF₂ₑ)—SO₂X′. It should be noted, however, that it may be desirable to not remove ionic fluoropolymer from the dispersion. Useful anion exchange resins typically comprise a polymer (typically crosslinked) that has a plurality of cationic groups (e.g., quaternary alkyl ammonium groups) paired with various anions (e.g., halide or hydroxide). Upon contact with the fluoropolymer dispersion, anionic impurities in the dispersion become associated with the anion exchange resin. After the anion exchange step, the resultant anion-exchanged dispersion is separated from the anion exchange resin, for example, by filtration. It was reported in U.S. Pat. No. 7,304,101 (Hintzer et al.) that the anionic hydrolyzed fluoropolymer does not appreciably become immobilized on the anion exchange resin, which would lead to coagulation and/or material loss. Anionic exchange resins are available commercially from a variety of sources. If the anion exchange resin is not in the hydroxide form it may be at least partially or fully converted to the hydroxide salt form before use. This is typically done by treating the anion exchange resin with an aqueous ammonia or sodium hydroxide solution. Typically, better yields are obtained using gel-type anion-exchange resins than with macroporous anion exchange resins.

Examples of cationic impurities resulting from the abovementioned polymerization include one or more of, alkali metal cation(s) (e.g., Li⁺, Na⁺, K⁺), ammonium, quaternary alkyl ammonium, alkaline earth cations (e.g., Mg²⁺, Ca²⁺), manganese cations (e.g., Mn²⁺), and Group III metal cations. Useful cation exchange resins include polymers (typically cross-linked) that have a plurality of pendant anionic or acidic groups such as, for example, polysulfonates or polysulfonic acids, polycarboxylates or polycarboxylic acids. Examples of useful sulfonic acid cation exchange resins include sulfonated styrene-divinylbenzene copolymers, sulfonated crosslinked styrene polymers, phenol-formaldehyde-sulfonic acid resins, and benzene-formaldehyde-sulfonic acid resins. Carboxylic acid cation exchange resin is an organic acid, cation exchange resin, such as carboxylic acid cation exchange resin. Cation exchange resins are available commercially from a variety of sources. Cation exchange resins are commonly supplied commercially in either their acid or their sodium form. If the cation exchange resin is not in the acid form (i.e., protonated form) it may be at least partially or fully converted to the acid form in order to avoid the generally undesired introduction of other cations into the dispersion. This conversion to the acid form may be accomplished by means well known in the art, for example by treatment with any adequately strong acid.

If purification of the fluorinated polymer latex is carried out using both anion and cation exchange processes, the anion exchange resin and cation exchange resin may be used individually or in combination as, for example, in the case of a mixed resin bed having both anion and cation exchange resins.

To coagulate the obtained fluorinated polymer latex, any coagulant which is commonly used for coagulation of a fluoropolymer latex may be used, and it may, for example, be a water-soluble salt (e.g., calcium chloride, magnesium chloride, aluminum chloride or aluminum nitrate), an acid (e.g., nitric acid, hydrochloric acid or sulfuric acid), or a water-soluble organic liquid (e.g., alcohol or acetone). The amount of the coagulant to be added may be in a range of 0.001 to 20 parts by mass, for example, in a range of 0.01 to 10 parts by mass per 100 parts by mass of the latex. Alternatively, or additionally, the latex may be frozen for coagulation or mechanically coagulated, for example, with a homogenizer as described in U.S. Pat. No. 5,463,021 (Beyer et al.). Alternatively, or additionally, the latex may be coagulated by adding polycations. It may also be useful to avoid acids and alkaline earth metal salts as coagulants to avoid metal contaminants. To avoid coagulation altogether and any contaminants from coagulants, spray drying the latex after polymerization and optional ion-exchange purification may be useful to provide solid fluorinated polymer.

A coagulated polymer can be collected by filtration and washed with water. The washing water may, for example, be ion-exchanged water, pure water, or ultrapure water. The amount of the washing water may be from 1 to 5 times by mass to the polymer, whereby the amount of the emulsifier attached to the polymer can be sufficiently reduced by one washing.

The polymer dispersion produced can have less than 50 ppm dissolved metal ion content, in some embodiments, less than 25 ppm, less than 10 ppm, less than 5 ppm, or less than 1 ppm metal ion content. Specifically, metal ions such as alkali metals, alkaline earth metal, heavy metals (e.g., nickel, cobalt, manganese, cadmium, and iron) can be reduced. To achieve a metal ion content of less than 50 ppm, 25 ppm, 10 ppm, 5 ppm, or 1 ppm, polymerization can be conducted in the absence of added metal ions. For example, potassium persulfate, a common alternative initiator or co-initiator with ammonium persulfate, is not used, and mechanical and freeze coagulation described above may be used instead of coagulation with metal salts. It is also possible to use organic initiators as disclosed in U.S. Pat. No. 5,182,342 (Feiring et al.). To achieve such low ion content, ion exchange can be used, as described above, and the water for polymerization and washing may be deionized.

The metal ion content of the copolymer can be measured by flame atomic absorption spectrometry after combusting the copolymer and dissolving the residue in an acidic aqueous solution. For potassium as the analyte, the lower detection limit is less than 1 ppm.

Fluoropolymers obtained by aqueous emulsion polymerization with inorganic initiators (e.g. persulfates, KMnO₄, etc.) typically have a high number of unstable carbon-based end groups (e.g. more than 200 —COOM or —COF end groups per 10⁶ carbon atoms, wherein M is hydrogen, a metal cation, or NH₂). For fluorinated ionomers useful, for example, in an electrochemical cell, the effect naturally increases as sulfonate equivalent weight decreases. These carbonyl end groups are vulnerable to peroxide radical attacks, which reduce the oxidative stability of the fluorinated ionomers. During operation of a fuel cell, electrolysis cell, or other electrochemical cell, peroxides can be formed. This degrades the fluorinated ionomers, and correspondingly reduces the operational life of the given electrolyte membrane.

As polymerized, the fluorinated polymer useful in the composite of the present disclosure can have up to 400 —COOM and —COF end groups per 10⁶ carbon atoms, wherein M is independently an alkyl group, a hydrogen atom, a metallic cation, or a quaternary ammonium cation. Advantageously, in some embodiments, the fluorinated polymer has up to 200 unstable end groups per 10⁶ carbon atoms. The unstable end groups are —COOM or —COF groups, wherein M is an alkyl group, a hydrogen atom, a metallic cation, or a quaternary ammonium cation. In some embodiments, the fluorinated polymer has up to 150, 100, 75, 50, 40, 30, 25, 20, 15, or 10 unstable end groups per 10⁶ carbon atoms. The number of unstable end groups can be determined by Fourier-transform infrared spectroscopy using the method described below. In some embodiments, the fluorinated polymer has up to 50 (in some embodiments, up to 40, 30, 25, 20, 15, or 10) unstable end groups per 10⁶ carbon atoms, as polymerized.

Fluorinated polymers according to some embodiments of the present disclosure have —SO₂X end groups. As described above, —SO₂X end groups can be introduced in the fluorinated polymers by generating SO₃⁻ radicals during the polymerization process.

In some embodiments, reducing the number of unstable end groups can be accomplished by carrying out the polymerization in the presence of a salt or pseudohalogen as described in U.S. Pat. No. 7,214,740 (Lochhaas et al.). Suitable salts can include a chloride anion, a bromide anion, an iodide anion, or a cyanide anion and a sodium, potassium, or ammonium cation. The salt used in the free-radical polymerization may be a homogenous salt or a blend of different salts. Examples of useful pseudohalogens are nitrile-containing compounds, which provide nitrile end groups. Pseudohalogen nitrile-containing compounds have one or more nitrile groups and function in the same manner as compounds in which the nitrile groups are replaced with a halogen. Examples of suitable pseudohalogen nitrile-containing compounds include NC—CN, NC—S—S—CN, NCS—CN, Cl—CN, Br—CN, I—CN, NCN—NCN, and combinations thereof. During the free-radical polymerization, the reactive atoms/groups of the salts or the nitrile groups of the pseudohalogens chemically bond to at least one end of the backbone chain of the fluoropolymer. This provides CF₂Y¹ end groups instead of carbonyl end groups, wherein Y¹ is chloro, bromo, iodo, or nitrile. For example, if the free-radical polymerization is performed in the presence of a KCl salt, at least one of the end groups provided would be a —CF₂Cl end group. Alternatively, if the free-radical polymerization is performed in the presence of a NC-CN pseudohalogen, at least one of the end groups provided would be a —CF₂CN end group.

Post-fluorination with fluorine gas can also be used to address unstable end groups and any concomitant degradation. Post-fluorination of the fluoropolymer can convert —COOH, amide, hydride, —COF, —CF₂Y¹ and other nonperfluorinated end groups or —CF═CF₂ to —CF₃ end groups. The post-fluorination may be carried out in any convenient manner. The post-fluorination can be conveniently carried out with nitrogen/fluorine gas mixtures in ratios of 75-90:25-10 at temperatures between 20° C. and 250° C., in some embodiments in a range of 150° C. to 250° C. or 70° C. to 120° C., and pressures from 10 KPa to 1000 KPa. Reaction times can range from about four hours to about 16 hours. Under these conditions, most unstable carbon-based end groups are removed, whereas —SO₂X groups mostly survive and are converted to —SO₂F groups. In some embodiments, post-fluorination is not carried out when non-fluorinated monomers as described above are used as monomers in the polymerization or when the fluorinated polymer useful in the composite of the present disclosure includes divalent units independently represented by formula:

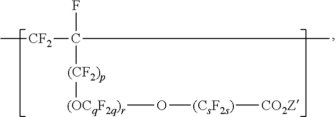

as described above in any of their embodiments.

The groups Y¹ in the end groups —CF₂Y¹, described above, are reactive to fluorine gas, which reduces the time and energy required to post-fluorinate the copolymers in these embodiments.

For precursors of the fluorinated polymers in which the —SO₂X groups are —SO₂F groups, the polymer can be treated with an amine (e.g., ammonia) to provide a sulfonamide (e.g., having —SO₂NH₂ groups). Sulfonamides made in this manner or prepared by using CF₂═CFCF₂—(OC_{b}F_{2b})_{c}—O—(CF₂)ₑ—SO₂NH₂ in the components that are polymerized as described above can be further reacted with multi-functional sulfonyl fluoride or sulfonyl chloride compounds. Examples of useful multi-functional compounds include 1,1,2,2-tetrafluoroethyl-1,3-disulfonyl fluoride; 1,1,2,2,3,3-hexafluoropropyl-1,3-disulfonyl fluoride; 1,1,2,2,3,3,4,4-octafluorobutyl-1,4-disulfonyl fluoride; 1,1,2,2,3,3,4,4,5,5-perfluoropentyl-1,5-disulfonyl fluoride; 1,1,2,2-tetrafluoroethyl-1,2-disulfonyl chloride; 1,1,2,2,3,3-hexafluoropropyl-1,3-disulfonyl chloride; 1,1,2,2,3,3,4,4-octafluorobutyl-1,4-disulfonyl chloride; and 1,1,2,2,3,3,4,4,5,5-perfluoropentyl-1,5-disulfonyl chloride. After hydrolysis of the sulfonyl halide groups, the resulting polymer, in which X is —NZSO₂(CF₂)₁₋₆SO₃Z, can have a higher number of ionic groups than the polymer as polymerized. Thus, the number of ionic groups can be increased and the equivalent weight decreased without affecting the backbone structure of the copolymer. Also, using a deficient amount multi-functional sulfonyl fluoride or sulfonyl chloride compounds can result in crosslinking of the polymer chains, which may be useful to improve durability in some cases (e.g., for fluorinated polymers having low equivalent weights). Further details can be found, for example, in U.S. Pat. Appl. Publ. No. 20020160272 (Tanaka et al.). To prevent such crosslinking, if desired, fluorinated polymers bearing —SO₂NH₂ groups can be treated with compounds represented by formula FSO₂(CF₂)₁₋₆SO₃H, which can be made by hydrolyzing any of the multi-functional sulfonyl fluorides or sulfonyl chlorides described above with one equivalent of water in the presence of base (e.g., N,N-diisopropylethylamine (DIPEA)) as described in JP 2011-40363, published Feb. 24, 2011. Fluorinated polymers bearing —SO₂NH₂ groups can also treated with polysulfonimides represented by formula FSO₂(CF₂)ₐ[SO₂NZSO₂(CF₂)ₐ]₁₋₁₀SO₂F or FSO₂(CF₂)ₐ[SO₂NZSO₂(CF₂)ₐ]₁₋₁₀SO₃H, wherein each a is independently 1 to 6, 1 to 4, or 2 to 4. To make a polysulfonimide, a sulfonyl halide monomer (e.g., any of those described above) and a sulfonamide monomer represented by formula H₂NSO₂(CF₂)ₐSO₂NH₂ are made to react in the mole ratio of (k+1)/k, in which k represents the moles of sulfonamide monomer and k+1 represents the moles of sulfonyl halide monomer. The reaction may be carried out, for example, in a suitable solvent (e.g., acetonitrile) at 0° C. in the presence of base. The sulfonyl halide monomer and sulfonamide monomer may have the same or different values of a, resulting in the same or different value of a for each repeating unit. The resulting product (e.g., FSO₂(CF₂)ₐ[SO₂NZSO₂(CF₂)ₐ]₁₋₁₀SO₂F) may be treated with one equivalent of water in the presence of base (e.g., N,N-diisopropylethylamine (DIPEA)) to provide, for example, FSO₂(CF₂)ₐ[SO₂NZSO₂(CF₂)ₐ]₁₋₁₀SO₃H, as described in JP 2011-40363.

In other embodiments, precursors of the fluorinated polymers in which the —SO₂X groups are —SO₂F groups can be treated with small molecule sulfonamides such as those represented by formula NH₂SO₂(CF₂)₁₋₆SO₃Z, wherein Z is as defined above in any of its embodiments, to provide —SO₂NHSO₂(CF₂)₁₋₆SO₃Z groups. Compounds represented by formula NH₂SO₂(CF₂)₁₋₆SO₃Z may be synthesized by reacting cyclic perfluorodisulfonic acid anhydrides with amines according to the methods described in U.S. Pat. No. 4,423,197 (Behr). This can also provide fluorinated polymers with very low equivalent weights.

The composite and polymer electrolyte membrane of the present disclosure includes nanoparticles of lithium fluoride. As used herein, the term “nanoparticles” refers to particles having a median particle size (or D₅₀) of less than one micrometer. “Particle size” refers to the maximum cross-sectional dimension of a particle and, in the case of spherical particles, may refer to the diameter. In some embodiments, the nanoparticles have a median particle size of less than 1000 nanometers (nm), less than 800 nm, less than 700 nm, less than 500 nm, or less than 250 nm, less than 100 nm. In some embodiments, the nanoparticles have a median particle size of greater than 400 nm, greater than 300 nm, greater than 200 nm, greater than 100 nm, greater than 60 nm, greater than 40 nm, greater than 20 nm, or greater than 10 nm. In some embodiments, the nanoparticles have a median particle size in a range from 5 nm to 1000 nm, 10 nm to 1000 nm, 10 nm to 800 nm, 10 nm to 500 nm, 10 nm to 300 nm, 50 nm to 800 nm, 100 nm to 800 nm, or 200 nm to 800 nm. Particle size can be measured using techniques known in the art. For example, scanning electron microscopy can be used to determine the particle size of nanoparticles. Alternatively, the particle size can be measured using a light scattering technique. Because light scattering techniques require the particles to be suspended in a liquid, the lithium fluoride particles can agglomerate resulting in a misleadingly high particle diameter. The agglomeration of the lithium fluoride particles can be mitigated by sonicating or otherwise disrupting the agglomerates prior to analysis. Certain mathematical formulations may be used (such as the Rosin-Rammler distribution) to try to more accurately determine the median or mean particle size when using the light scattering techniques. The nanoparticles of lithium fluoride may have a monodisperse size distribution or a polymodal distribution.

It has been discovered that smaller sized lithium fluoride nanoparticles appear to outperform larger sized lithium fluoride particles and other metal salts. As mentioned, lithium fluoride nanoparticles can agglomerate in solution resulting in difficultly accurately quantitating their diameter by light scattering techniques. Thus, the present disclosure is directed toward those particles that have higher surface area. Brunauer Emmett Teller (BET) is commonly used to determine surface area and involves adsorbing a monolayer of nitrogen on the surface of the particle under cryogenic conditions. The lithium fluoride particles of the present disclosure, on average, have a high surface area, for example, at least 10 m²/g, at least 14 m²/g, at least 20 m²/g, at least 25 m²/g, or at least 30 m²/g; and at most 400 m²/g, at most 300 m²/g, at most 200 m²/g, at most 100 m²/g, or at most 75 m²/g based on BET nitrogen adsorption.

In one embodiment, the composition comprises additional metal salts in addition to the nanoparticles of lithium fluoride having a high surface area. Suitable metal salts typically are hydrophilic, but have a low solubility in water. In some embodiments, the metal salt has a solubility product (Kₛₚ) of less than 1×10⁻⁴. In some embodiments, the metal salt has a solubility product (Kₛₚ) of less than 1×10⁻⁴, less than 1×10⁻⁶, or less than 1×10⁻⁸. The solubility product is the product of the molar concentrations of the constituent ions, each raised to the power of its stoichiometric coefficient in the equilibrium equation. A small solubility product value indicates low solubility. The solubility product is measured in water at 25° C. and can be found in reference books such as the CRC Handbook of Chemistry and Physics or Lange's Handbook of Chemistry. In case of a disagreement between the reference books, for the purposes of this disclosure, the solubility product is found in the CRC Handbook of Chemistry. Examples of suitable metal salts that could be additionally added include BaSO₄, PbSO₄, CaSO₄, MgSO₄, CaF₂, and BsF₂.

In one embodiment, in addition to the high surface area lithium fluoride nanoparticles mentioned above, lithium fluoride particles having a lower surface area also may be added to the composite. Such lower surface area particles have a BET surface area of less than 10, 8, 5, or even 2 m²/g. One of ordinary skill in the art should be able to tell if lower surface area particles are present or were added due to the presence of a multimodal particle size distribution. The multimodial distribution can be observed by analyzing the particles using standard sizing techniques, such as laser scatter or scanning electron microscopy imaging. If these lower surface area lithium fluoride particles are used, they would be present in an amount of less than 10% by weight based on the total weight of all lithium fluoride particles present.

The amount of lithium fluoride nanoparticles with a high surface area can be selected such that it is effective to increase the proton-conductivity of a polymer electrolyte membrane of the present disclosure at temperature of at least 100° C. and a relative humidity of less than 50%. The effective amounts depend on the fluorinated polymer and the surface area of the lithium fluoride, but are typically in the range from molar ratios of —SO₃⁻Z group to lithium fluoride of from about 1:2 to about 20:1, in some embodiments, from about 1:1.5 to 15:1, from about 1:1 to 10:1, from about 1:1 to 5:1, or from about 1:1 to 2:1. The molar ratios may further be adjusted with respect to specific desired mechanical or rheological properties of the membranes depending on their intended use, for example, swelling behavior, density, and mechanical stability.

In some embodiments, the nanoparticles of lithium fluoride with a high surface area are present in the composite in a range from one percent to 30 percent by weight, one percent to 25 percent by weight, one percent to 20 percent by weight, one percent to 15 percent by weight, or five percent to 15 percent by weight, based on the total weight of the composite.

Lithium fluoride can be made using techniques known in the art such as reaction of lithium hydroxide with hydrofluoric acid, which can then be purified by crystallization. Lithium fluoride is available commercially from manufacturers such as Fisher Chemical and Sigma Aldrich.

To achieve the high surface area useful in the composite of the present disclosure, the lithium fluoride can be processed to reduce its particle size and thus, increase its surface area. In one embodiment, particles of lithium fluoride are milled to decrease the particle size before incorporation into the ionomer. For example, dry lithium fluoride particles are pulverized in a grinder, jet mill, ball mill, etc. Alternatively, the lithium fluoride particles are suspended in a liquid and then pulverized. In one embodiment, the liquid is a protic solvent such as alcohol (e.g., isopropanol, ethanol, butanol), water, or combinations thereof.

In some embodiments, the composite of the present disclosure further comprises plate-like fillers. Plate-like fillers may also be known as flakes, platy fillers, or platelet fillers. Plate-like filler have aspect ratios of at least 5:1, 10:1, or 20:1 and may have aspect ratios up to 50:1, 100:1, or higher. Aspect ratio is defined as the ratio of the longest dimension divided by the shortest dimension. In the case of plate-like fillers, there are two long dimensions and one short dimension. Typically, when either of the two long dimensions is measured, the aspect ratio of the plate-like filler is at least 5:1, 10:1, or 20:1 and up to 50:1, 100:1, or higher. At least one of the long dimensions and typically both long dimensions in the plate-like fillers useful for practicing the present disclosure is greater than one micrometer, in some embodiments, at least 5 micrometers, 10 micrometers, 20 micrometers, 25 micrometers, 50 micrometers, or at least 100 micrometers.

Plate-like fillers useful in the composites of the present disclosure include boron nitride platelets, glass flakes, talc, and mica. In some embodiments, the composites of the present disclosure include at least one of glass flakes or boron nitride platelets. A variety of glass compositions may be useful for the glass flakes (e.g., calcium sodium borosilicate glass, fused silica glass, aluminosilicate glass, borosilicate glass, or glass obtained under the trade designation “VYCOR” from Corning, Inc., New York). In some embodiments, the glass flakes are Ca/Na glass flakes. Useful plate-like fillers can have thicknesses (smallest dimension), in some embodiments, from 1 micrometer to 20 micrometers.

In some embodiments, the plate-like fillers are coated with the nanoparticles of the lithium fluoride described above in any of their embodiments. In some embodiments, at least some of the nanoparticles of lithium fluoride are coated on the plate-like filler. In some embodiments, the composite incudes further nanoparticles of the lithium fluoride, not coated on the plate-like filler. In some embodiments, the composite does not include further nanoparticles of the metal salt, not coated on the plate-like filler. Nanoparticles of the lithium fluoride can be coated on the plate-like fillers, for example, by adding the plate-like fillers to the emulsion described above useful for preparing the nanoparticles.

The composite of the present disclosure can be prepared by combining one or more of the fluorinated polymers and nanoparticles of lithium fluoride. A useful method includes combining components comprising organic solvent, optionally water, at least ten percent by weight of the fluorinated polymer of the present disclosure, based on the total weight of the components, and the nanoparticles, and mixing the components at ambient temperature and pressure to make a dispersion. Examples of suitable organic solvents useful for preparing the dispersions include, lower alcohols (e.g., methanol, ethanol, isopropanol, n-propanol), polyols (e.g., ethylene glycol, propylene glycol, glycerol), ethers (e.g., tetrahydrofuran and dioxane), diglyme, polyglycol ethers, ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. In some embodiments, the fluorinated polymer, nanoparticles of lithium fluoride, organic solvent, and water can be heated at a pressure of up to 0.2 MPa or 0.15 MPa at a temperature of up to 100° C., 90° C., 80° C., 70° C., 60° C., 50° C., or 40° C. Advantageously, the dispersion may also be made at ambient temperature and pressure. The composite may be formed by casting the dispersion into a mold and drying optionally at elevated temperature to form the composite.

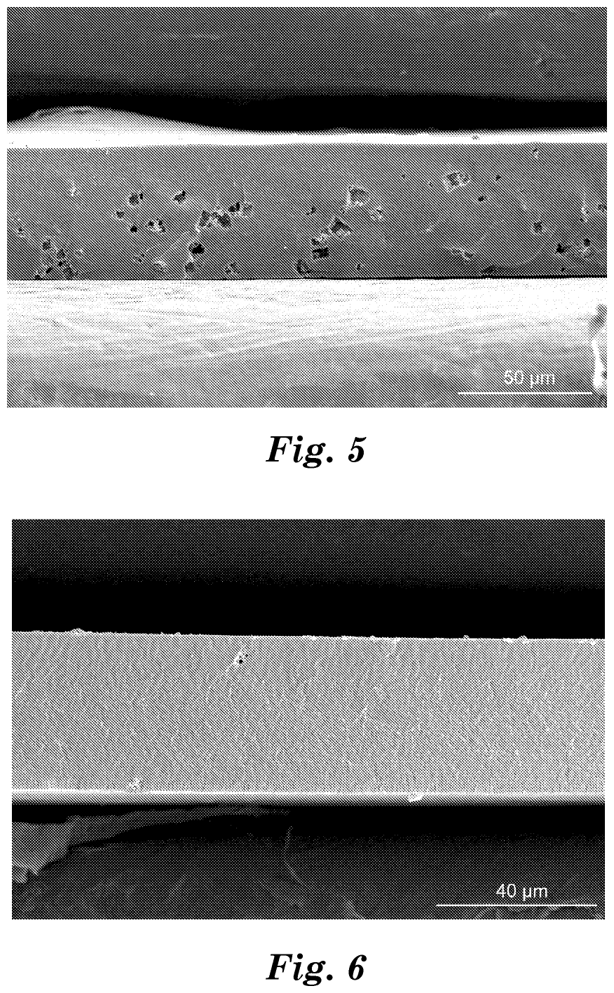

The composite of the present disclosure may be useful, for example, in the manufacture of polymer electrolyte membranes for use in fuel cells or other electrolytic cells. A membrane electrode assembly (MEA) is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. Each electrode layer includes electrochemical catalysts, typically including platinum metal. Gas diffusion layers (GDL's) facilitate gas transport to and from the anode and cathode electrode materials and conduct electrical current. The GDL may also be called a fluid transport layer (FTL) or a diffuser/current collector (DCC). A schematic representation of an embodiment of an MEA is illustrated in FIG. 5 of U.S. Pat. Appl. Pub. No. 2011/0303868 (Sienkiewicz et al.), incorporated herein by reference. The anode and cathode electrode layers may be applied to GDL's in the form of a catalyst ink, and the resulting coated GDL's sandwiched with a PEM to form a five-layer MEA. Alternately, the anode and cathode electrode layers may be applied to opposite sides of the PEM in the form of a catalyst ink, and the resulting catalyst-coated membrane (CCM) sandwiched with two GDL's to form a five-layer MEA. Details concerning the preparation of catalyst inks and their use in membrane assemblies can be found, for example, in U.S. Pat. Publ. No. 2004/0107869 (Velamakanni et al.). In a typical PEM fuel cell, protons are formed at the anode via hydrogen oxidation and transported across the PEM to the cathode to react with oxygen, causing electrical current to flow in an external circuit connecting the electrodes. The PEM forms a durable, non-porous, electrically non-conductive mechanical barrier between the reactant gases, yet it also passes H⁺ ions readily.

The composite of the present disclosure may be useful as and/or useful for making a catalyst ink composition. In some embodiments, the fluorinated polymer and nanoparticles of lithium fluoride (e.g., as components of a dispersion) can be combined with catalyst particles (e.g., metal particles or carbon-supported metal particles). A variety of catalysts may be useful. Typically, carbon-supported catalyst particles are used. Typical carbon-supported catalyst particles are 50% to 90% carbon and 10% to 50% catalyst metal by weight, the catalyst metal typically comprising platinum for the cathode and platinum and ruthenium in a weight ratio of 2:1 for the anode. However, other metals may be useful, for example, gold, silver, palladium, iridium, rhodium, ruthenium, iron, cobalt, nickel, chromium, tungsten, manganese, vanadium, and alloys thereof. To make an MEA or CCM, catalyst may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications. The catalyst ink may be applied to a PEM or a GDL directly, or the catalyst ink may be applied to a transfer substrate, dried, and thereafter applied to the PEM or to the FTL as a decal.

In some embodiments, the catalyst ink includes the composite disclosed herein at a concentration of at least 10, 15, or 20 percent by weight and up to 30 percent by weight, based on the total weight of the catalyst ink. In some embodiments, the catalyst ink includes the catalyst particles in an amount of at least 10, 15, or 20 percent by weight and up to 50, 40, or 30 percent by weight, based on the total weight of the catalyst ink. The catalyst particles may be added to the dispersion or fluorinated polymer and nanoparticles of lithium fluoride as described above in any of its embodiments. The resulting catalyst ink may be mixed, for example, with heating. The percent solid in the catalyst ink may be selected, for example, to obtain desirable rheological properties. Examples of suitable organic solvents useful for including in the catalyst ink include, lower alcohols (e.g., methanol, ethanol, isopropanol, n-propanol), polyols (e.g., ethylene glycol, propylene glycol, glycerol), ethers (e.g., tetrahydrofuran and dioxane), diglyme, polyglycol ethers, ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. In some embodiments, the catalyst ink contains 0% to 50% by weight of a lower alcohol and 0% to 20% by weight of a polyol. In addition, the ink may contain 0% to 2% of a suitable dispersant.

The polymer electrolyte membrane of the present disclosure may be formed into a polymer electrolyte membrane by any suitable method, including casting, molding, and extrusion. Typically, the membrane is cast from a dispersion of fluorinated polymer and nanoparticles (e.g., those described above in any of their embodiments) and then dried, annealed, or both. The membrane may be cast from a suspension. The concentration of fluorinated polymer in the dispersion can advantageously be high (e.g., at least 20, 30, or 40 percent by weight). Often a water-miscible organic solvent is added to facilitate film formation. Examples of water-miscible solvents include, lower alcohols (e.g., methanol, ethanol, isopropanol, n-propanol), polyols (e.g., ethylene glycol, propylene glycol, glycerol), ethers (e.g., tetrahydrofuran and dioxane), ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. Any suitable casting method may be used, including bar coating, spray coating, slit coating, and brush coating. After forming, the membrane may be annealed, typically at a temperature of 120° C. or higher, more typically 130° C. or higher, most typically 150° C. or higher. In some embodiments of the method according to the present disclosure, a polymer electrolyte membrane can be obtained by obtaining the copolymer in a fluoropolymer dispersion, optionally purifying the dispersion by ion-exchange purification, and concentrating the dispersion to make a membrane.

The present disclosure provides a membrane electrode assembly comprising at least one of a catalyst ink comprising the composite of the present disclosure or a polymer electrolyte membrane comprising the composite of the present disclosure. In some embodiments, the polymer electrolyte membrane and catalyst ink use embodiments of the composite disclosed herein. The catalyst ink and polymer electrolyte membrane may use the same or different fluorinated polymer. In some embodiments, the catalyst ink comprises the composite of the present disclosure, and the polymer electrolyte membrane includes a conventional ionomer (e.g., one that does not include nanoparticles of a metal salt). In some embodiments, the polymer electrolyte membrane is prepared from the composite of the present disclosure, and the catalyst ink includes a conventional copolymer (e.g., one that does not include nanoparticles of a metal salt).

In some embodiments of the polymer electrolyte membrane of the present disclosure, a salt of at least one of cerium, manganese or ruthenium or one or more cerium oxide or zirconium oxide compounds is added to the acid form of the copolymer before membrane formation. Typically, the salt of cerium, manganese, or ruthenium and/or the cerium or zirconium oxide compound is mixed well with or dissolved within the copolymer to achieve substantially uniform distribution.

The salt of cerium, manganese, or ruthenium may comprise any suitable anion, including chloride, bromide, hydroxide, nitrate, sulfonate, acetate, phosphate, and carbonate. More than one anion may be present. Other salts may be present, including salts that include other metal cations or ammonium cations. Once cation exchange occurs between the transition metal salt and the acid form of the ionomer, it may be desirable for the acid formed by combination of the liberated proton and the original salt anion to be removed. Thus, it may be useful to use anions that generate volatile or soluble acids, for example chloride or nitrate. Manganese cations may be in any suitable oxidation state, including Mn²⁺, Mn³⁺, and Mn⁴⁺, but are most typically Mn²⁺ Ruthenium cations may be in any suitable oxidation state, including Ru³⁺ and Ru⁴⁺, but are most typically Ru³⁺. Cerium cations may be in any suitable oxidation state, including Ce³⁺ and Ce⁴⁺. Without wishing to be bound by theory, it is believed that the cerium, manganese, or ruthenium cations persist in the polymer electrolyte because they are exchanged with H⁺ ions from the anion groups of the polymer electrolyte and become associated with those anion groups. Furthermore, it is believed that polyvalent cerium, manganese, or ruthenium cations may form crosslinks between anion groups of the polymer electrolyte, further adding to the stability of the polymer. In some embodiments, the salt may be present in solid form. The cations may be present in a combination of two or more forms including solvated cation, cation associated with bound anion groups of the polymer electrolyte membrane, and cation bound in a salt precipitate. The amount of salt added is typically between 0.001 and 0.5 charge equivalents based on the molar amount of acid functional groups present in the polymer electrolyte, more typically between 0.005 and 0.2, more typically between 0.01 and 0.1, and more typically between 0.02 and 0.05. Further details for combining an anionic copolymer with cerium, manganese, or ruthenium cations can be found in U.S. Pat. Nos. 7,572,534 and 8,628,871, each to Frey et al.

Useful cerium oxide compounds may contain cerium in the (IV) oxidation state, the (III) oxidation state, or both and may be crystalline or amorphous. The cerium oxide may be, for example, CeO₂ or Ce₂O₃. The cerium oxide may be substantially free of metallic cerium or may contain metallic cerium. The cerium oxide may be, for example, a thin oxidation reaction product on a metallic cerium particle. The cerium oxide compound may or may not contain other metal elements. Examples of mixed metal oxide compounds comprising cerium oxide include solid solutions such as zirconia-ceria and multicomponent oxide compounds such as barium cerate. Without wishing to be bound by theory, it is believed that the cerium oxide may strengthen the polymer by chelating and forming crosslinks between bound anionic groups. The amount of cerium oxide compound added is typically between 0.01 and 5 weight percent based on the total weight of the copolymer, more typically between 0.1 and 2 weight percent, and more typically between 0.2 and 0.3 weight percent. The cerium oxide compound is typically present in an amount of less than 1% by volume relative to the total volume of the polymer electrolyte membrane, more typically less than 0.8% by volume, and more typically less than 0.5% by volume. Cerium oxide may be in particles of any suitable size, in some embodiments, between 1 nm and 5000 nm, 200 nm to 5000 nm, or 500 nm to 1000 nm. Further details regarding polymer electrolyte membranes including cerium oxide compounds can be found in U.S. Pat. No. 8,367,267 (Frey et al.).

The polymer electrolyte membrane, in some embodiments, may have a thickness of up to 90 microns, up to 60 microns, or up to 30 microns. A thinner membrane may provide less resistance to the passage of ions. In fuel cell use, this results in cooler operation and greater output of usable energy. Thinner membranes must be made of materials that maintain their structural integrity in use.

In some embodiments, the composite of the present disclosure may be imbibed into a porous supporting matrix, typically in the form of a thin membrane having a thickness of up to 90 microns, up to 60 microns, or up to 30 microns. Any suitable method of imbibing the copolymer into the pores of the supporting matrix may be used, including overpressure, vacuum, wicking, and immersion. In some embodiments, the composite is embedded in the matrix upon crosslinking. Any suitable supporting matrix may be used. Typically, the supporting matrix is electrically non-conductive. Typically, the supporting matrix is composed of a fluoropolymer, which is more typically perfluorinated. Typical matrices include porous polytetrafluoroethylene (PTFE), such as biaxially stretched PTFE webs. In another embodiment fillers (e.g. fibers) might be added to the polymer to reinforce the membrane.

To make an MEA, GDL's may be applied to either side of a CCM by any suitable means. Any suitable GDL may be used in the practice of the present disclosure. Typically, the GDL is comprised of sheet material comprising carbon fibers. Typically, the GDL is a carbon fiber construction selected from woven and non-woven carbon fiber constructions. Carbon fiber constructions which may be useful in the practice of the present disclosure may include Toray™ Carbon Paper, SpectraCarb™ Carbon Paper, AFN™ non-woven carbon cloth, and Zoltek™ Carbon Cloth. The GDL may be coated or impregnated with various materials, including carbon particle coatings, hydrophilizing treatments, and hydrophobizing treatments such as coating with polytetrafluoroethylene (PTFE).

In use, the MEA according to the present disclosure is typically sandwiched between two rigid plates, known as distribution plates, also known as bipolar plates (BPP's) or monopolar plates. Like the GDL, the distribution plate is typically electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” A typical fuel cell stack comprises a number of MEA's stacked alternately with bipolar plates.

Another type of electrochemical device is an electrolysis cell, which uses electricity to produce chemical changes or chemical energy. An example of an electrolysis cell is a chlor-alkali membrane cell where aqueous sodium chloride is electrolyzed by an electric current between an anode and a cathode. The electrolyte is separated into an anolyte portion and a catholyte portion by a membrane subject to harsh conditions. In chlor-alkali membrane cells, caustic sodium hydroxide collects in the catholyte portion, hydrogen gas is evolved at the cathode portion, and chlorine gas is evolved from the sodium chloride-rich anolyte portion at the anode. The composite of the present disclosure may be useful, for example, in the manufacture of catalyst ink and electrolyte membranes for use in chlor-alkali membrane cells or other electrolytic cells.

The polymer electrolyte membranes as provided herein are cation-conductive, depending on the counterion of the polysulfonic acid groups. Typically, the counterion is a hydrogen proton and the membranes are proton-conductive. The membranes provided herein may be proton-conductive at room temperature, but may also have a good proton conductivity even at low levels of humidity and/or elevated temperatures such as, for example, at a temperature of greater than about 90° C., at least 100° C., at least 110° C., at least 120° C., at least 130° C.; and at most 140° C. and/or a humidity level of less than 60% relative humidity (rH), less than 50% rH, less than 40% rH, less than 30% rH, less than 20% rH, less than 10% rH. In some embodiments, the relative humidity is between 10-60%, between 40-60%, 10-40%, 20-40%, 10-30%, 20-30%, 10-20%, or even 15-20%. The polymer electrolyte membranes of the present disclosure may have a proton conductivity of at least about 0.01 Siemens/cm, at least about 0.03 Siemens/cm in an operating range of, e.g., between about 70° C. and about 130° C. In some embodiments, or even at least about 0.1 Siemens/cm the membranes have a proton conductivity of at least 0.01 Siemens/cm at a temperature between about 90° C. and 130° C. and a relative humidity of less than about 60%, in some embodiments, less than 30% relative humidity, or even less than 20% relative humidity. Advantageously, in some embodiments, the proton conductivity of the polymer electrolyte membrane of the present disclosure is increased by at least 100%, at least 200%, at least 250%, at least 275%, or at least 290% at a temperature of at least 90° C. and/or a humidity level of 60% relative humidity relative to a polymer electrolyte membrane that is otherwise the same but does not include the high surface area lithium fluoride nanoparticles. In some embodiments, the proton conductivity of the polymer electrolyte membrane of the present disclosure is increased by at least 100%, at least 200%, at least 250%, at least 275%, or at least 290% at a temperature of 110° C. and/or a humidity level of 25% relative humidity relative to a polymer electrolyte membrane that is otherwise the same but does not include the high surface area lithium fluoride nanoparticles. In some embodiments, the proton conductivity of the polymer electrolyte membrane of the present disclosure is increased by at least 100%, at least 200%, at least 250%, at least 275%, or at least 290% at a temperature of 130° C. and/or a humidity level of 15% relative humidity relative to a polymer electrolyte membrane that is otherwise the same but does not include the high surface area lithium fluoride nanoparticles. Proton conductivity is measured using the method described in the Examples, below.

Ionomers typically exhibit a thermal transition between a state in which the ionic clusters are closely associated and a state in which the interactions between those clusters have been weakened. This transition is described as an alpha transition, and the transition temperature is T(α). Ionomers with higher T(α) typically have greater mechanical integrity at elevated temperatures than corresponding materials with lower T(α). As a result, to obtain high service temperatures for an ionomer, a relatively high T(α) can be desirable for ionomers. The presence of high surface area nanoparticles of a lithium fluoride can increase the T(α) of the polymer electrolyte membrane. Dynamic mechanical analysis (DMA) is a useful tool for measuring T(α), as polymer physical property changes accompany this transition. The DMA sample cell may be set up in torsion, compression, or tension. In one embodiment, the addition of high surface area lithium fluoride nanoparticles to the fluorinated polymer can increase the T(α) by at least 5° C., or at least 7° C. relative to a fluorinated polymer membrane that is otherwise the same, but does not include the high surface area lithium fluoride nanoparticles.

Incorporation of nanoparticles of lithium fluoride can also advantageously improve the mechanical properties of the composite of the present disclosure. For example, the storage modulus of a membrane at a temperature of greater than about 90° C., at least 100° C., at least 110° C., at least 120° C., or at least 130° C. can be increased by at least 100%, at least 150%, at least 200%, at least 250%, at least 300%, at least 500%, or at least 800% relative to a membrane that is otherwise the same but does not include the high surface area lithium fluoride nanoparticles.

The polymer electrolyte membrane of the present disclosure shows reduced potential loss per hour by almost an order of magnitude over the same polymer electrolyte membrane, wherein the high surface area lithium fluoride particles are replaced with a similar high surface area of calcium fluoride. In one embodiment, the polymer electrolyte membrane of the present disclosure, when tested as disclosed in the Examples below, has a potential loss per hour of less than 5 mV/h, less than 4 mV/h, or less than 3 mV/h.

The polymer electrolyte membrane of the present disclosure shows a power gain greater than the same polymer electrolyte membrane with no additional metal salt particles included. In one embodiment, the polymer electrolyte membrane of the present disclosure, when tested as disclosed in the Examples below, has a power gain of at least 5 mW/cm², at least 8 mW/cm², or at least 10 mW/cm².

### EXAMPLES

Unless otherwise noted, all parts, percentages, ratios, etc. in the examples and the rest of the specification are by weight, and all reagents used in the examples were obtained, or are available, from general chemical suppliers such as, for example, MilliporeSigma, St. Louis, Mo., USA, or known to those skilled in the art, unless otherwise stated or apparent.

The following abbreviations are used in this section: mL=milliliters, g=grams, m=meters, cm=centimeters, mm=millimeters, μm=micrometers, nm=nanometers, wt. %=percent by weight, min=minutes, h=hours, eq=equivalent, EW=equivalent weight, V=volts, mV-millivolts, A=amps, U=potential, I=current, mbar=millibar, rpm=revolutions per minute, ° C.=degrees Celsius, mW=milliwatts, MPa=megapascals.

Materials Used in the Examples

| Abbreviation | Description and Source |
|---|---|
| EW 800 | Copolymer of TFE and CF₂═CF—O—(CF₂)₄SO₂F having |
| | an equivalent weight of 800 obtained under the |
| | trade designation “3M IONOMER 800 EW” from 3M, St. |
| | Paul, Minn. |
| FILLER A | LiF, obtained from Merck KGaA |
| FILLER B | FILLER A, milled as described below under |
| | “Preparation of Nanoparticles” |
| FILLER C | CaF₂, obtained from SigmaAldrich, milled as |
| | described below under “Preparation of Nanoparticles” |

### Preparation of Nanoparticles

FILLER B and FILLER C were prepared by wet milling by using a planetary ball mill where the milling container and ball were made of zirconium oxide. LiF or CaF₂ was used with 3 times amount of isopropanol. The ball mill was conducted for 20 h at 250 rpm rotational speed. The suspension was filtered and the solids were transferred to a polytetrafluoroethylene (PTFE) dish. The milled nanoparticles were dried in the PTFE dish at 60° C. overnight (100% yield).

### Method for Surface Area

The Brunauer-Emmett-Teller (BET) specific surface area was determined. The average surface area of the particles was measured by gas adsorption analysis according to the BET method using nitrogen gas as analysis adsorptive and liquid nitrogen to maintain a constant temperature of −196° C. The measurement was performed on a micromeritics ASAP 2010, with control of the instrument as well as evaluation of the data with the software ASAP 2010 V4.01. About 0.2 to 1.0 g of powder was placed in a tube stem with outer diameter of 12.7 mm and 9 cm³ bulb. The samples were outgassed at 80° C. at 10-3 mbar for twelve hours prior to analysis. The sample cell was weighed again before measurement. The adsorption measurement was performed in automatic analysis mode. Samples were evacuated at 10⁻⁶ mbar for at least 20 to 30 min before measurement. The specific surface determination was run using an eight-point multipoint BET analysis with nitrogen gas for partial pressures from 0.07 to 0.2. The average surface area is presented in Table 2.

### Method for Particle Size

The particle size was obtained by dispersing the designated metal fluoride particles in water at 5 weight %. A laser diffraction particle size analyzer (model PSA 1190L/D available from Anton Paar, Graz, Austria) was used to measure the particle size distribution. The instrument measured the D₁₀, D₅₀, and D₉₀ values and the mean particle size. The results are shown in Table 2.

TABLE 2

| | FILLER A | FILLER B | FILLER C |
|---|---|---|---|
| BET surface area (m²/g) | 1.3 | 21.8 | 21.9 |
| D₁₀ [μm] | 3.466 | 0.11577 | 0.14064 |
| D₅₀ [μm] | 6.978 | 0.6466 | 0.7876 |
| D₉₀ [μm] | 12.820 | 18.763 | 3.641 |
| Mean size [μm] | 8.043 | 4.773 | 1.5389 |

### Scanning Electron Microscopy (SEM)

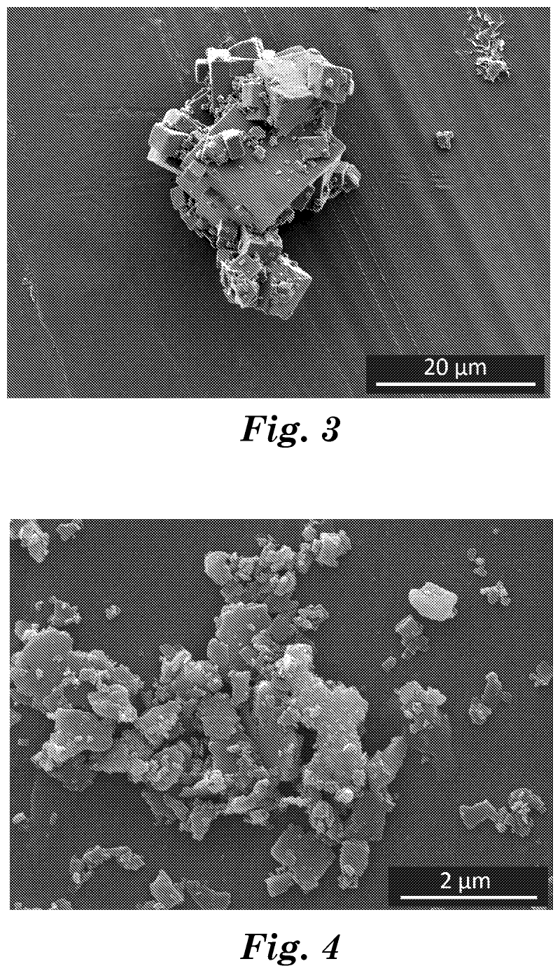

The morphology of the designated fillers was examined using a scanning electron microscope (SEM, Quanta FEG 250 available from FEI Company Hillsboro, OR). FIGS. 3-4 are the SEM images of Fillers A and B, respectively

### Method for OCV and Polarization Curve

The following measurements were performed using a FuelCon/Horiba Evaluator-C50-LT at three different temperatures (80° C., 120° C. and 130° C.). The membrane-electrode-assembly was prepared by hot-pressing the electrodes on the newly prepared membranes.

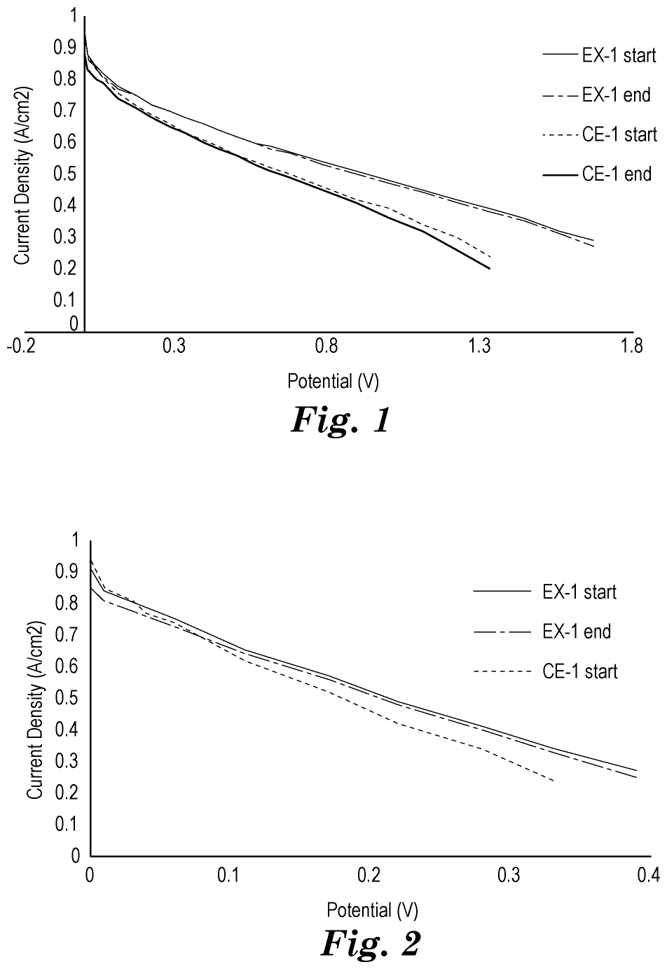

The measurements at 80° C. were run for 125 h and interrupted every 24 h to record a polarization curve. The measurements at 130° C. were carried out for 8 h or were stopped when the potential dropped below 0.4 V and interrupted every 6 h to record a polarization curve. OCV results measured at 80 and 130° C. are presented in Table 3. The measurements at 120° C. were run for 15 h and interrupted every 6 h to record a polarization curve. OCV results measured at 120° C. are presented in Table 4. Shown in FIG. 1 is the first polarization curve (0 hour) and the last polarization curve (curve at 125 hr) measured at 80° C. for Example 1 and Comparative Example 1. Shown in FIG. 2 is the first polarization curve (0 hour) and the last polarization curve (curve at 125 hr) measured at 130° C. for Example 1 and Comparative Example 1. In FIG. 2, there is no “CE-1 end” data as the OCV tests had to be stopped before the second U/I curve was recorded. “Start” indicates the potential measured 15 minutes before the first polarization curve and “End” is the potential 1 hour after the last polarization curve.

### Method for Preparing MEA

Membrane-electrode-assemblies (MEA) were prepared by hot-pressing electrodes (anode, cathode) to prepared membranes at 180° C. for 1 min at 0.4 MPa. The anode contained 0.1 mg/cm² of Pt and 0.2 mg/cm² of Ru and the thickness was 3 μm. The cathode contained 0.4 mg/cm² Pt and the thickness was 9 μm. The gas diffusion layer (GDL) (SGL Carbon, Sigratec Typ 10AA) was laid down on the catalyst coated membrane (CCM) and the area of the MEA was 9 cm².

### Proton Conductivity

A BekkTech conductivity cell was used to measure proton conductivity. The measuring cell was held at the specified temperature. The water reservoir under the cell was held constant at 70° C. (dew point). In this manner with increasing temperature, the relative humidity (rH) decreased and is reported in Table 5. An equilibration of 2.5 hours was used. Membranes were prepared as described in CE-1, CE-2 and EX-1. The membrane used in the measurements was 10 mm×20 mm in dimension and was stamped out using a die. The membrane thickness was 25 μm and was laid in water for 15 minutes prior to being put in the conductivity cell. The analyzed frequency range was between 1 MHz and 20 Hz and the potentiostat had an amplitude of 20 mV. The impedances were measured in-plane. The measuring clamp was constructed according to a commercial BekkTech cell. The results are shown in Table 5.

### Determination of T(α) and Storage Modulus

Dynamic mechanical analysis equipment (MCR 702e MultiDrive) from Anton Paar (Graz, Austria) was used to determine Talpha and storage modulus. Membranes were prepared as described in CE-1, and EX-1. The thickness of the sample to be tested was 300 μm, with a length of 3 cm and a width of 0.8 cm. The measurement was performed in extensional mode. The heating rate was 2° C./min, from 30° C. to 140° C. and a frequency of 10 Hz. The results are shown in Table 6. Comparative Example 1 (CE-1):

For CE-1, 0.5 g of EW 800 was first suspended in 4.5 mL n-propanol/water solution (95/5) and stirred for 36 h (ionomer loading: 10 wt %). The ionomer slurry was degassed on a rotary evaporator so that no more air bubbles were present that could have affected the quality of the membrane. In addition, excess solvent was evaporated until the optimum viscosity was reached. The dispersion was poured onto a plate covered with Kapton film, which was placed on a Coatmaster 509 MC doctoring table available from ERICHSEN GmbH & Co. KG. In the casting process, the doctor blade was pulled over the dispersion with a gap height of 650 μm and a speed rate of 10 mm/s, resulting in a uniform composite membrane. After the doctor-blading process, the membrane was left to rest for 15 min to allow it to dry lightly on the Kapton film before it was dried at 60° C. for 30 min in a drying oven. After a final annealing step at 180° C. for 10 min, the membrane was tested for T(α) and storage modulus, along with its proton conductivity or was used to prepare an MEA according to the procedure described in “Method for Preparing MEA”.

### Example 1 (EX-1) and Comparative Examples 2 and 3 (CE-2 and CE-3)

For EX-1, 0.5 g of EW 800 was first suspended in 4.5 mL n-propanol/water solution (95/5) and stirred for 36 h (ionomer loading: 10 wt %). After weighing the amount of FILLER B (55 mg: 10 wt % loading referred to ionomer portion), it was dispersed with 1 mL of n-propanol for 30 min in an ultrasonic bath to break up possible agglomerates. It was then added to the polymer dispersion and stirred until a homogeneous suspension was obtained. The additive-monomer slurry was degassed on a rotary evaporator so that no more air bubbles were present that could have affected the quality of the membrane. In addition, excess solvent was evaporated for 5 min at 40° C. at 60 mbar. The dispersion was poured onto a plate covered with Kapton film, which was placed on the Coatmaster 509 MC doctoring table. In the casting process, the doctor blade was pulled over the dispersion with a gap height of 650 μm and a speed rate of 10 mm/s, resulting in a uniform composite membrane. After the doctor-blading process, the membrane was left to rest for 15 min to allow it to dry lightly on the Kapton film before it was dried at 60° C. for 30 min in a drying oven. After a final annealing step at 180° C. for 10 min, the composite membrane was tested for T alpha and storage modulus, along with its proton conductivity or was used to prepare an MEA according to the procedure described in “Method for Preparing MEA.”

For CE-2 and CE-3, the process was followed as described for EX-1, with the exception that 55 mg of FILLER A was used in place of FILLER B for CE-2 and 55 mg of FILLER C was used in place of FILLER B for CE-3.

The composite membranes of CE-2 and EX-1 were examined by SEM. CE-2 and EX-1 were cryo-fractured and the exposed cross section was imaged by SEM (Quanta FEG 250 available from FEI Company Hillsboro, OR). FIG. 5 is the cross-sectional image of CE-2 and FIG. 6 is the cross-sectional image of EX-1.

TABLE 3
Characterization

| | Example or Comparative Example | | | | | | | |
|---|---|---|---|---|---|---|---|---|
| Parameter | CE-1 | | | | EX-1 | | | |
| Temperature | 80° | C. | 130° | C. | 80° | C. | 130° | C. |
| Duration | 125 | h | 5 | h | 125 | h | 5 | h |
| Potential (Start) is 15 | 939 | mV | 939 | mV | 957 | mV | 908 | mV |
| minutes before 1^{st} | | | | | | | | |
| polarization curve | | | | | | | | |
| Potential (End) is 1 hour | 878 | mV | 569 | mV | 950 | mV | 901 | mV |
| after last polarization curve | | | | | | | | |
| Potential loss | 61 | mV | 370 | mV | 7 | mV | 7 | mV |
| Power density/MPP^{†} at 1^{st} | 385 | mW/cm² | 94 | mW/cm² | 518 | mW/cm² | 115 | mW/cm² |

| polarization curve | | | | | | | |
|---|---|---|---|---|---|---|---|
| Power density/MPP at last | 363 | mW/cm² | * | 506 | mW/cm² | 112 | mW/cm² ^{‡} |
| polarization curve | | | | | | | |
| Power loss | 22 | mW/cm² | * | 12 | mW/cm² | 3 | mW/cm² ^{‡} |

* OCV tests had to be stopped before the second U/I-curve was recorded.
^{‡} after 6 h.
^{†}MPP= maximum power point

TABLE 4
Characterization

| | Example or Comparative Example | | | | | | | |
|---|---|---|---|---|---|---|---|---|
| Parameter | CE-1 | | CE-2 | | EX-1 | | CE-3 | |
| Temperature | 120° | C. | 120° | C. | 120° | C. | 120° | C. |
| Duration | 15 | h | 3 | h* | 15 | h | 15 | h |
| Potential (Start) | 985 | mV | 780 | mV | 925 | mV | 855 | mV |
| Potential (End) | 836 | mV | 494 | mV ^{‡} | 893 | mV | 572 | mV |
| Potential loss | 149 | mV | 286 | mV | 32 | mV | 283 | mV |
| Potential loss per hour | 9.93 | mV/h | 95.33 | mV/h | 2.13 | mV/h | 18.87 | mV/h |
| Power density/MPP at 1^{st} | 88 | mW/cm² | 173 | mW/cm² | 126 | mW/cm² | 146 | mW/cm² |

| polarization curve | | | | | | | |
|---|---|---|---|---|---|---|---|
| Power density/MPP at last | 92 | mW/cm² | * | 137 | mW/cm² | 111 | mW/cm² |
| polarization curve | | | | | | | |
| Power gain/loss | +4 | mW/cm² | * | +11 | mW/cm² | −35 | mW/cm² |

*OCV tests had to be stopped after 3 h (second U/I-curve was recorded).
^{‡} after 3 h.

TABLE 5
Proton Conductivity

| | CE-1 | | CE-2 | | EX-1 | |
|---|---|---|---|---|---|---|
| 70° C. (95% rH) | 263.0 | mS/cm | NM | | 326.1 | mS/cm |
| 90° C. (60% rH) | 66.2 | mS/cm | 45.7 | mS/cm | 147.4 | mS/cm |
| 110° C. (25% rH) | 17.4 | mS/cm | 20.1 | mS/cm | 39.2 | mS/cm |
| 130° C. (15% rH) | 4.2 | mS/cm | 9.1 | mS/cm | 12.4 | mS/cm |

NM = not measured

TABLE 6
Storage Modulus and T(α)

| | CE-1 | | EX-1 | |
|---|---|---|---|---|
| T(α) | 122° | C. | 129° | C. |

Extensional Storage Modulus E′

| | | | | | |
|---|---|---|---|---|---|
| 70° | C. | 229.6 | MPa | 295.7 | MPa |
| 90° | C. | 198.0 | MPa | 302.1 | MPa |
| 110° | C. | 62.0 | MPa | 169.5 | MPa |
| 130° | C. | 3.9 | MPa | 31.7 | MPa |

NM = not measured

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A composite comprising a fluorinated polymer and nanoparticles of lithium fluoride having an average BET surface area of at least 10 m²/g, the fluorinated polymer comprising a fluorinated polymer backbone chain and a plurality of groups represented by formula —SO₂X, wherein each X is independently —NZH, NZSO₂(CF₂)₁₋₆SO₂X′, —NZ[SO₂(CF₂)_{d}SO₂NZ]₁₋₁₀SO₂(CF₂)_{d}SO₂X′, or —OZ, wherein Z is independently a hydrogen, an alkali-metal cation, or a quaternary ammonium cation, X′ is independently —NZH or —OZ, and each d is independently 1 to 6.

2. The composite of claim 1, wherein at least some of the plurality of the groups represented by formula —SO₂X are part of the side chains pendent from the fluorinated polymer backbone, wherein the side chains are represented by formula:
-Rp-SO₂X,
wherein Rp is bonded to the fluorinated polymer backbone and is a linear, branched, or cyclic perfluorinated or partially fluorinated alkyl or alkoxy group optionally interrupted by one or more —O— groups.

3. The composite of claim 1, wherein the fluorinated polymer comprises:
divalent units represented by formula —[CF₂—CF₂]—; and
at least one divalent unit independently represented by formula: 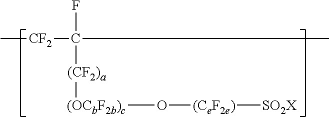
wherein a is 0 or 1, each b is independently 2 to 8, c is 0 to 2, e is 1 to 8, and each X is independently —NZH, —NZSO₂(CF₂)₁₋₆SO₂X′, —NZ[SO₂(CF₂)_{d}SO₂NZ]₁₋₁₀SO₂(CF₂)_{d}SO₂X′, or —OZ, wherein Z is independently a hydrogen, an alkali-metal cation, or a quaternary ammonium cation, X′ is independently —NZH or —OZ, and each d is independently 1 to 6.

4. The composite of claim 3, wherein b is 2 or 3, c is 0 or 1, and e is 2 to 4.

5. The composite of claim 1, wherein each X is independently —OZ.

6. The composite of claim 1, further comprising at least one divalent unit represented by formula 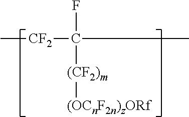
wherein Rf is a linear or branched perfluoroalkyl group having from 1 to 8 carbon atoms and optionally interrupted by one or more —O— groups, z is 0, 1, or 2, each n is independently 1, 2, 3, or 4, and m is 0 or 1.

7. The composite of claim 1, wherein the fluorinated polymer has an —SO₂X equivalent weight in a range from 300 to 1200.

8. The composite of claim 1, wherein the nanoparticles of lithium fluoride have a median particle size of up to 1000 nanometers.

9. The composite of claim 1, further comprising plate-like filler.

10. The composite of claim 9, wherein at least some of the nanoparticles of lithium fluoride are coated on the plate-like filler.

11. The composite of claim 1, wherein the nanoparticles of lithium fluoride are present in the composite in a range from one percent to 30 percent by weight, based on the total weight of the composite.

12. The composite of claim 1, wherein the composite further comprises a second plurality of lithium fluoride particles, wherein the second plurality of lithium fluoride particles have a surface area of less than 10 m²/g and are present at less than 10% by weight versus total weight of lithium fluoride present.

13. A polymer electrolyte membrane prepared from the composite of claim 1.

14. The polymer electrolyte membrane of claim 13, further comprising at least one of cerium cations, manganese cations, ruthenium cations, or cerium oxide.

15. A membrane electrode assembly comprising the composite of any claim 1 in a polymer electrolyte membrane, in an electrode, or both in a polymer electrolyte membrane and in an electrode.
